(19) United States
(12) Patent Application Publication
(10) Pub. No.: US 2026/0081760 A1
(43) Pub. Date: Mar. 19, 2026

(54) SECURE KEY UTILIZATION IN A DISTRIBUTED HARDWARE SECURITY MODULE

(71) Applicant: Microsoft Technology Licensing, LLC, Redmond, WA (US)

(72) Inventors: Bryan David KELLY, Carnation, WA (US); Mark Eugene RUSSINOVICH, Medina, WA (US); Hervey Oliver WILSON, Bellevue, WA (US)

(21) Appl. No.: 18/890,107

(22) Filed: Sep. 19, 2024

(51) Int. Cl. H04L 9/08; G06F 21/53; H04L 9/32

(52) U.S. Cl. CPC H04L 9/0822; H04L 9/0825; G06F 21/53; H04L 9/3263

(57) ABSTRACT

Systems, methods, and computer readable storage media described herein for secure key utilization in a distributed hardware security module. In an aspect, a hardware security module is communicatively coupled to and physically separate from a host processor. The hardware security module comprises a security coprocessor. The security coprocessor receives, over a network and from a central security module, a first cryptographic key. The first cryptographic key is stored in a secure data store. A request to perform a cryptographic operation is received from the first host processor. The security coprocessor utilizes the first cryptographic key to perform the cryptographic operation, resulting in a cryptographic result. In one aspect, the cryptographic result to the first host processor. In another aspect, the cryptographic result is written to host memory. In another aspect, the hardware security module notifies the host processor that the cryptographic operation was completed.

### BACKGROUND

In cloud service and enterprise network implementations, key management is utilized to securely store keys and security assets. A centralized security module stores keys and security assets on a network and is accessed remotely by applications on behalf of users. In some implementations, a user is able to check a key out of the centralized security module. The centralized security module releases the key into the user's virtualized environment, where it is held in memory of the user's virtual machine hosting a workload.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein provide secure key utilization in a distributed hardware security module. In an aspect, a hardware security module is communicatively coupled to and physically separate from a host processor. The hardware security module comprises a security coprocessor and memory comprising programming instructions structured to cause the security coprocessor to: receive, over a network and from a central security module, a first cryptographic key; store the first cryptographic key in a secure data store; receive, from the first host processor, a request to perform a cryptographic operation; utilize the first cryptographic key to perform the cryptographic operation, resulting in a cryptographic result; and provide the cryptographic result to the first host processor.

In a further aspect, the hardware security module comprises a first partition comprising a first interface and a second partition comprising a second interface. The first virtual machine is bound to the first partition. The binding configures the first interface to receive the request to perform the cryptographic operation and prevents the virtual machine from sending the request to the second interface.

In a further aspect, the hardware security module monitors operation of hardware and firmware of the server device. Responsive to detecting a tamper event based on a result of said monitoring, the hardware security module encrypts the first cryptographic key with a migration key, resulting in a wrapped key. The hardware security module causes the wrapped key to be transmitted to a second hardware security module.

In a further aspect, the hardware security module determines a storage criterion of the hardware security module is satisfied. The hardware security module utilizes the public wrapping key to encrypt the first cryptographic key, resulting in a wrapped key. The hardware security module causes the host processor to store the wrapped key in a host memory.

In an alternative aspect, the hardware security module: receives key material over a network and from a central security module; generates a cryptographic key from the key material; receives, from the host processor, a request to perform a cryptographic operation; utilizes the cryptographic key to perform the cryptographic operation; resulting in a cryptographic result; and provides, to the host processor, an indication that the cryptographic operation is completed.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for secure key utilization in a distributed hardware security module, in accordance with an example embodiment.

FIG. 2 shows a block diagram of another example system for secure key utilization in a distributed hardware security module, in accordance with another example embodiment.

FIG. 3 shows a flowchart of a process for secure key utilization in a distributed hardware security module, in accordance with an example embodiment.

FIG. 4 shows a flowchart of a process for receiving a cryptographic key, in accordance with an example embodiment.

FIG. 5 shows a flowchart of a process for requesting a cryptographic key, in accordance with an example embodiment.

FIG. 6 shows a block diagram of another example system for secure key utilization in a distributed hardware security module, in accordance with another example embodiment.

FIG. 7 shows a flowchart of another process for receiving a cryptographic key, in accordance with another example embodiment.

FIG. 8 shows a block diagram of example system for secure key utilization in a partitioned distributed hardware security module, in accordance with example embodiment.

FIG. 9 shows a flowchart of a process for partitioning a distributed hardware security module, in accordance with an example embodiment.

FIG. 10 shows a flowchart of a process for secure key utilization in a partitioned distributed hardware security module, in accordance with example embodiment.

FIG. 11 shows a block diagram of an example system for migrating keys from a distributed hardware security module to another hardware security module, in accordance with an example embodiment.

FIG. 12 shows a flowchart of a process for migrating keys from a distributed hardware security module to another hardware security module, in accordance with an example embodiment.

FIG. 13 shows a block diagram of an example system for utilizing host memory to securely store keys, in accordance with an example embodiment.

FIG. 14 shows a flowchart of a process for utilizing host memory to securely store keys, in accordance with an example embodiment.

FIG. 15 shows a flowchart of a process for accessing keys securely stored in host memory, in accordance with an example embodiment.

FIG. 16 shows a block diagram of an example system for system attestation and tamper event detection, in accordance with an example embodiment.

FIG. 17 shows a flowchart of a process for attesting the validity of a system, in accordance with an example embodiment.

FIG. 18 shows a flowchart of a process for mitigating a tamper event, in accordance with an example embodiment.

FIG. 19 shows a flowchart of a process for mitigating a tamper event utilizing a mitigation service, in accordance with an example embodiment.

FIG. 20 shows a flowchart of a process for migrating a key to mitigate a tamper event, in accordance with an example embodiment.

FIG. 21 shows a flowchart of a process for early tamper event detection, in accordance with an example embodiment.

FIG. 22 shows a block diagram of a system for verifying firmware of a distributed firmware, in accordance with an example embodiment.

FIG. 23 shows a flowchart of a process verifying firmware of a distributed firmware, in accordance with an example embodiment.

FIG. 24 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments Utilizing a Distributed Hardware Module

In cloud service and enterprise network implementations, key management is utilized to securely store keys and security assets. For instance, some implementations of cloud services and enterprise networks utilize a centralized security module that stores keys and security assets. The centralized security module is network-accessible to servers on the cloud/enterprise network. In some implementations, the centralized security module performs cryptographic operations on behalf of a server without releasing stored keys to a server. This requires a network round trip between the server and the centralized security module, which is time consuming and resource intensive, as the server and the centralized security module can be physically distant from each other (e.g., located in different areas of a data center). Furthermore, as more servers utilize the centralized security module, the module's bandwidth for fulfilling requests lessens, further increasing the time to fulfill a request.

Some implementations of centralized security modules allow a server to check out a key from the centralized security module. This process, also referred to as “key release”, releases the key in a virtualized environment on the server (e.g., a virtual machine on the server) such that the workload is able to utilize the key to perform operations. In this context, the key is held in memory of the virtual machine hosting the workload. A malicious entity (e.g., a hacker or other type of cyber attacker) can leverage this release of a key to access the key through a side channel or direct memory dump attack. Once the malicious entity has access to the key, they are able to access a user's sensitive data and/or communications.

Embodiments of the present disclosure provide secure key utilization in network-based systems. In embodiments, servers of the network-based system include a distributed hardware security module (HSM). The distributed HSM provides platform integrity and secure key management on the respective server. In an aspect, the distributed HSM receives a cryptographic key from the central security module (e.g., a key vault or a central HSM) in a manner that prevents exposure of an unencrypted version of the cryptographic key to the host system (e.g., the server's processor and memory) and guests of the server (e.g., virtual machines and other virtual assets hosted by the host system). The distributed HSM stores the cryptographic key in a secure, isolated data store such that access by the host system and guests is prevented. The distributed HSM receives requests from the host system and/or guest of the server and performs cryptographic operations on behalf of the requestor without exposing the cryptographic key to the host or guest. By leveraging a distributed HSM on the server, embodiments of the present disclosure reduce network traffic of the central HSM, as (e.g., only) a request for the keys to be released to the distributed HSM is to be fulfilled, and other requests for cryptographic operations are submitted to the distributed HSM. Thus, time and compute resources to perform cryptographic operations are reduced. Furthermore, embodiments of a distributed HSM improve/enforce system security in other ways as well. For instance, in some implementations, the distributed HSM enforces attestation policies (e.g., binding a key to hardware/firmware/software, determining if a requesting system is bound to the key, attesting the authenticity of code, etc.).

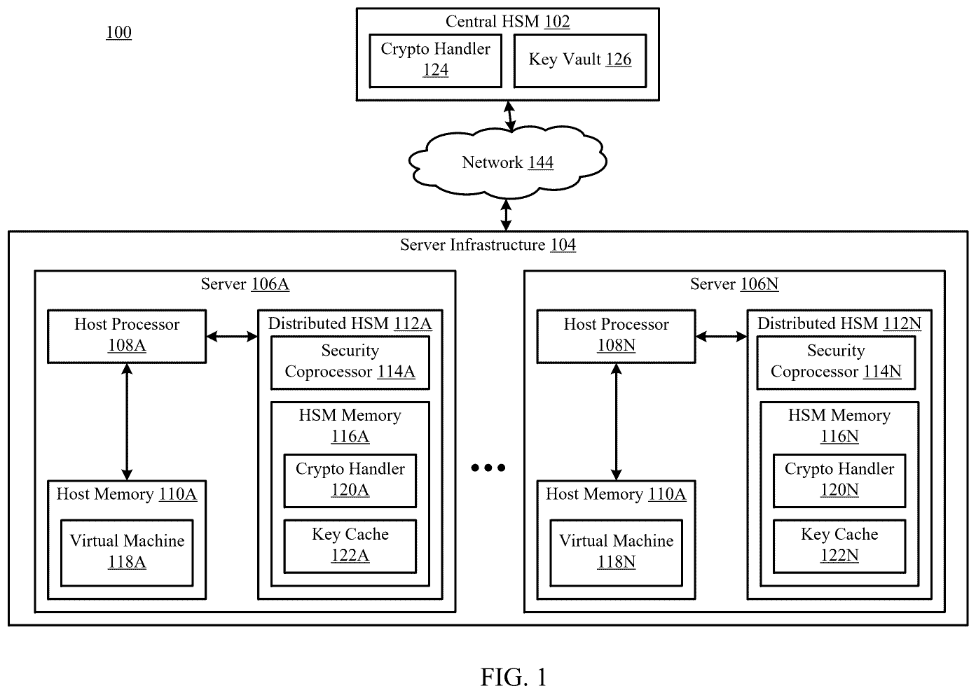

Embodiments of systems implementing distributed HSMs are configurable in various ways. For instance, FIG. 1 shows a block diagram of an example system 100 for secure key utilization in a distributed hardware security module, in accordance with an example embodiment. As shown in FIG. 1, system 100 comprises a central HSM 102 and a server infrastructure 104, each of which are communicatively coupled via a network 144 (in accordance with an embodiment). In examples, network 144 comprises one or more networks such as local area networks (LANs), wide area networks (WANs), enterprise networks, the Internet, etc. In examples, network 144 comprises one or more wired and/or wireless portions. The features of system 100 are described in detail as follows.

Central HSM 102 is configured to store and distribute keys for performing cryptographic operations on behalf of users (e.g., tenants) of a cloud service. In embodiments, central HSM 102 is implemented on a server or other computing device. As shown in FIG. 1, central HSM 102 comprises a crypto handler 124 and a key vault 126. Key vault 126 is configured to store keys of users of a cloud service. Crypto handler 124 is configured to distribute keys from key vault 126 to distributed HSMs of server infrastructure 104. By distributing keys to local HSMs, a user's asset executed by a server of server infrastructure 104 is able to leverage the local HSM to perform cryptographic operations without placing additional communication to the central HSM (which takes time).

Server infrastructure 104 is a network-accessible server set (e.g., a cloud-based environment or platform). As shown in FIG. 1, server infrastructure 104 comprises one or more servers 106A-106N (collectively referred to as “servers 106A-106N”). In embodiments, servers 106A-106N are arranged as individual servers, server racks comprising multiple servers, tiles comprising multiple racks, and/or the like. For instance, in an embodiment, servers 106A-106N are arranged in one or more room(s) of a data center. A data center is a building, a group of buildings (each collocated buildings), or one or more rooms within a building. A data center is configured to house servers 106A-106N and/or other computing systems and associated components. In accordance with an embodiment, central HSM 102 and server infrastructure 104 are collocated in the same data center.

Each of servers 106A-106N comprises a server computer, server system, and/or another type of computing device (e.g., a desktop computer, a mobile or handheld device (e.g., a tablet, a personal data assistant (PDA), a smart phone, a laptop, etc.), an Internet-of-Things (IoT) device, etc.). Servers 106A-106N comprise computing components and are configured to host assets (e.g., virtual machines, applications, storage, etc.). For instance, as shown in FIG. 1, server 106A comprises a host processor 108A, a host memory 110A, and a distributed HSM 112A (“HSM 112A” herein), and server 106N comprises a host processor 108N, a host memory 110N, and a distributed HSM 112N (“HSM 112N” herein).

Host memory 110A and 110N are any type of memory device configured to store data. For instance, in accordance with an embodiment, and as shown in FIG. 1, host memory 110A stores virtual machine 118A and host memory 110N stores virtual machine 118N. In some embodiments, host memory 110A and host processor 108A are co-packaged (e.g., in a single System-on-Chip package) and/or host memory 110N and host processor 108N are co-packaged.

Host processors 108A and 108N are configured to perform tasks such as, but not limited to, program execution, signal coding, data processing, input/output processing, power control, and/or other functions. For instance, in embodiments, host processors 108A and 108N are configured to execute guest computing assets on behalf of users of a cloud computing service. Examples of guest computing assets include, but are not limited to, virtual machines, virtual machine scale sets, machine learning (ML) workspaces (e.g., a group of compute intensive virtual machines for training ML models and/or performing other processing intensive tasks), serverless functions, storage disks, web applications, database servers, data objects (e.g., data file(s), table(s), structured data, unstructured data, etc.), a cluster (e.g., a cluster of nodes), and/or any other type of software and/or network resource associated with a user's computing environment described elsewhere herein. For example, as shown in FIG. 1, host processor 108A executes a virtual machine 118A stored in host memory 110A and host processor 108N executes a virtual machine 118N stored in host memory 110N.

HSM 112A and HSM 112N are configured to provide secure key utilization for respective servers 106A and 106N. For instance, HSM 112A and/or HSM 112N provide respective hardware roots of trust for their respective servers. As shown in FIG. 1, HSM 112A comprises a security coprocessor 114A and an HSM memory 116A and HSM 112N comprises a security coprocessor 114N and an HSM memory 116N. In some embodiments, HSM 112A and/or HSM 112N comprise a hardware trusted platform module (TPM). HSM memories 116A and 116N are memory devices of respective HSMs 112A and 112N and are configured to store code (e.g., firmware) executable by respective security coprocessors 114A and 114N and store keys managed by respective HSMs 112A and 112N. For instance, HSM memory 116A stores a crypto handler 120A and a key cache 122A and HSM memory 116N stores a crypto handler 120N and a key cache 122N. Crypto handlers 120A and 120N are configured to perform cryptographic operations and other operations associated with secure key utilization, as described elsewhere herein. Key caches 122A and 122N are configured to store keys managed by respective HSMs 112A and 112N, as described elsewhere herein.

Security coprocessors 114A and 114N are configured to perform tasks such as, but not limited to, program execution, signal coding, data processing, input/output processing, power control, and/or other functions of respective HSMs 112A and 112N. For example, in an embodiment, security coprocessor 114A is configured to execute crypto handler 116A and interact with key cache 122A and security coprocessor 114N is configured to execute crypto handler 120N and interact with key cache 122N.

In embodiments, HSMs 112A and 112N are physically separate from respective host processors 108A and 108N and respective host memories 110A and 110N. In this context, HSMs 112A and 112N provide hardware isolation in compliance with a security standard (e.g., National Institute of Standards and Technology cybersecurity standards). Host/guest software and firmware interacting with HSMs 112A and/or 112N (e.g., only) receive implicit access to key usage through the respective HSM (e.g., the key usage is enforced within the isolated hardware environment of the respective HSM and is not exposed to the software/firmware interacting therewith).

Furthermore, HSM memories 116A and 116N are separate from (e.g., physically isolated from) respective host memories 110A and 110N. By maintaining separate memory from the host, HSMs 112A and 112N prevent the host from accessing sensitive data (e.g., keys, secrets, etc.) stored in HSM memories 116A and 116N. In this context, HSMs 112A and 112N prevent (or reduce system susceptibility to) side-channel attacks where an attacker exploits data leaked in the execution of software by host processors 108A and 108N.

Each of HSMs 112A and 112N have one or more confidential interfaces (e.g., confidential input/output interfaces, peripheral component interconnect express (PCIe) interfaces with link encryption, and/or the like) accessible to respective host processors 108A and 108N (not shown in FIG. 1 for brevity). A confidential interface enables the respective host processor to transmit requests to and/or receive responses from the respective distributed HSM. In accordance with an embodiment, a secure link between the confidential interface of the distributed HSM and the respective host processor is active across resets of the distributed HSM (e.g., across a soft reset, across a PCIe frontend reset (“warm reset”), etc.). By maintaining the secure link in this manner, the distributed HSM is able to update without impacting the connection with the host processor (e.g., without having to re-establish the connection, which takes time and compute resources).

HSMs 112A and 112N perform various secure operations for their respective server and guests of the server (e.g., virtual machines executed on the server). Example secure operations include, but are not limited to, determining platform integrity (e.g., determining if the server and/or a guest are infected with malware, attesting the validity of host firmware and/or guest firmware, or managing regional access to firmware storage), recovering a guest platform (e.g., recovering a guest after detecting corruption in the server or guest or initiating recover), detecting a tamper event (e.g., detecting a hardware tamper event or detecting a software tamper event), logging a tamper event, providing TMP functions (e.g., attesting hardware or providing hardware protection for keys, measuring hardware, measuring firmware, measuring software, reading a platform configuration register (PCR), extending a PCR, sealing a key based on a PCR value, unsealing a key based on a PCR value, and/or other functions of a TMP), securely storing keys (e.g., in memory of the distributed HSM or in memory of the host), receiving and storing keys on behalf of a tenant and/or cloud service provider (e.g., including verifying the key is valid based on a signature of the tenant and/or cloud service provider), generating keys (e.g., random key generation, key generation based on attributes of the system the distributed HSM operates in, key generation based on an attribute received from a central HSM, key generation based on an attribute of a cloud service provider, generating an elliptic curve cryptography (ECC) key, etc.), performing (e.g., symmetric or asymmetric) cryptographic operations (e.g., encrypting/decrypting data (e.g., utilizing a secure hash algorithm (SHA) function (e.g., SHA-256, SHA-384, SHA-512, etc.), utilizing an advanced encryption standard (AES) function (e.g., AES 128 bit, AES 256 bit, etc.), utilizing a message authentication code (MAC) (e.g., a hash-based MAC (e.g., HMAC SHA-256, an HMAC based key derivation function, etc.), a cipher-based message authentication code (CMAC) (e.g., AES-CMAC key derivation), etc.), a key wrap function, etc.), signing and/or verifying a signature (e.g., utilizing a digital signature algorithm (DSA) (e.g., an RSA algorithm), utilizing an elliptic curve DSA (ECDSA) (e.g., ECC 256, ECC 384, ECC 521), etc.) (e.g., a hash signature), verifying a signature, and/or other cryptographic operations), maintaining a monotonic counter, maintaining a secure clock (e.g., for network time protocol (NTP) with anti-time rollback), generating random entropy (e.g., utilizing a deterministic random big generator), and/or performing any other operations in a secure platform on a computing device. By providing an isolated platform for performing secure operations, HSMs 112A and 112N provide confidential computing through protection of user secrets. For instance, HSMs 112A and 112N maintain private keys that are not accessible to the host computing device, allowing the HSM to perform cryptographic operations utilizing the keys without exposing data to the host computing device (e.g., host processors 108A and 108N). In an embodiment, security coprocessor 114A executes code (e.g., firmware) to perform a secure operation on behalf of server 106A and security coprocessor 114N executes code to perform a secure operation on behalf of server 106N.

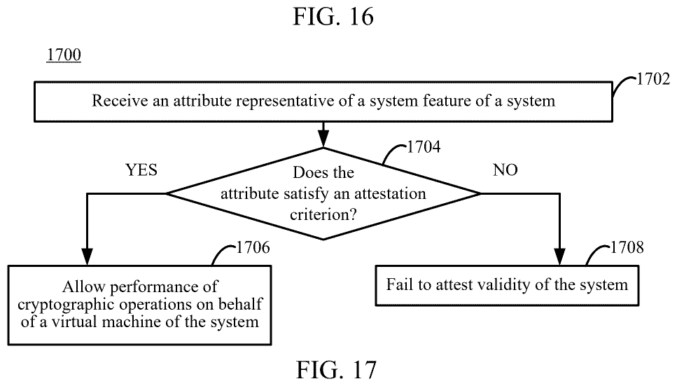

In some embodiments, HSMs 112A and/or 112N are powered by a separate and/or additional power source than respective host processors 108A and 108N. For instance, in accordance with an embodiment further described with respect to FIG. 16, HSM 112A comprises a battery to power a real-time clock and (e.g., some of) HSM 112A even if server 108A is unpowered. By having a separate (or additional) power source, such distributed HSMs are able to perform secure operations (e.g., detect tamper events) when server 108A is unpowered. Additional details regarding the use of a real-time clock are described with respect to FIG. 16, as well as elsewhere herein.

In accordance with an embodiment, HSMs 112A and/or 112N implement impactless firmware update. In this context, firmware of the HSM is updatable without impacting a workload handled by the HSM. For instance, the HSM receives a firmware update (e.g., from a user that has authorization to update firmware of the HSM, or from an HSM provider, as described elsewhere herein). The HSM saves the firmware update while the current firmware is operating. Subsequent to the firmware update being saved to memory, the HSM is ready to update from the current firmware to the new firmware. The HSM determines a period of time where the system can restart with little to no impact to HSM utilization by the host and causes the HSM to restart. For instance, the HSM determines to restart during a period at which the host has frozen data plane traffic, during a period where there are no outstanding commands, and/or the HSM is otherwise quiesced. As part of the restart process, the old firmware is discarded from memory and the new firmware is executed. The new firmware reinitializes communication with drivers and management applications, as described elsewhere herein. In an implementation, a host or other external entity is able to read firmware status during restart and the activation of the new firmware. For instance, in accordance with an embodiment, a PCIe link is maintained between the host and the HSM.

In some examples, state information and ongoing conversations with external entities (e.g., drivers, management agents, provisioning agents) is maintained across firmware updates (e.g., at a configuration level, not necessarily a per I/O level). In this context, state data is transferred during the firmware update. For instance, when the host is in a quiesced state and the HSM determines to update firmware, the HSM provides the host a notification indicating the firmware is being updated such that the state does not change. In this context, the new firmware activates with the state data from the old firmware and the host is able to exit its quiesced state.

Key cache 122A and key cache 122N are memory isolated from respective host memories 110A and 110N and are configured to securely store keys utilized by and/or generated by respective HSMs 112A and 112N. In embodiments, key cache 122A and key cache 122N are hardware protected and not exposed to firmware or software of respective hosts. In embodiments, crypto handler 120A wraps keys stored in key cache 122A such that they are accessible (e.g., only) to HSM 112A and crypto handler 120N wraps keys stored in key cache 122N such that they are accessible (e.g., only) to HSM 112N.

In an embodiment, HSM memory 116A and/or HSM memory 116N also store measurements (e.g., unified extensible firmware interface (UEFI) measurements, integrity measurements, external device measurements, accessory measurements, etc.) for attestation. In this context, the respective HSM is able to attest firmware and hardware of components in the respective server and enforces attestation policies. In this context, the HSM acts as a platform root of trust for the respective server. As a separate component from the host processor, the HSM has line-of-sight of physically local devices (e.g., the baseboard management controller (BMC), the power supply unit (PSU), bridges, etc.) as well as devices that are physically remote from the host processor (e.g., sensors of the server, system-on-chips (SoCs) of the server (e.g., hardware accelerators, other SoCs, etc.). Additional details regarding attestation are described with respect to FIGS. 16 and 17, as well as elsewhere herein.

In accordance with an embodiment, host processor 108A is uniquely bound to HSM 112A and host processor 108N is uniquely bound to HSM 112N. For instance, in the process of manufacturing of host processor 108A and HSM 112A (or in the process of manufacturing server 106A or a motherboard of server 106A comprising processor 108A and HSM 112A), a device certificate is issued for host processor 108A and HSM 112A that binds the two devices to each other. In another example embodiment, a chip-unique key pair is fused to HSM 112A that is utilized in exchange protocols between host processor 108A and HSM 112A for host and HSM 112A authentication. This binding during the manufacture of host processor 108A and HSM 112A (or the device comprising them) increases protection against physical tampering with the motherboard of server 106A to bypass or implant between HSM 112A and host processor 108A (e.g., with the intention of subverting security, faking firmware measurements, replacing HSM 112A with another (e.g., compromised or fake) HSM, etc.).

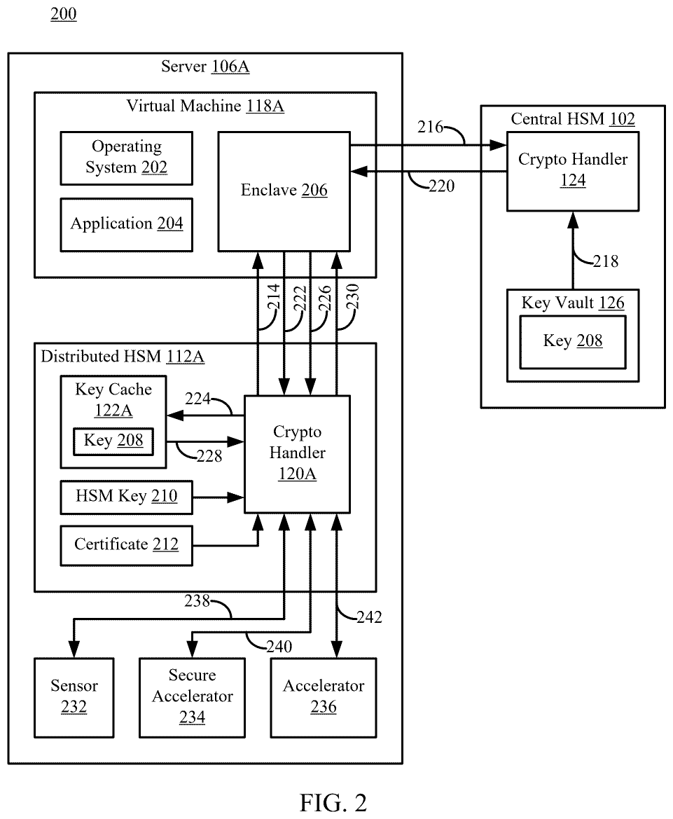

Embodiments of distributed HSMs are configured in various ways for secure key utilization. For instance, FIG. 2 shows a block diagram of another example system 200 for secure key utilization in a distributed hardware security module, in accordance with another example embodiment. As shown in FIG. 2, system 200 comprises central HSM 102 (comprising crypto handler 124 and key vault 126) and server 106A as described with respect to FIG. 1. As also shown in FIG. 2, server 106A comprises virtual machine 118A and distributed HSM 112A, as described with respect to FIG. 1, as well as a sensor 232, a secure accelerator 234, and an accelerator 236. The functions of system 200 are described as follows.

Sensor 232 is any type of sensor configured to detect or measure a physical property (e.g., voltage, frequency, temperature, motion, and/or the like) and record, indicate, or otherwise respond to the property. Secure accelerator 234 and accelerator 236 are configured to perform functions (e.g., data transfer operations, cryptographic operations, graphics processing operations, ML operations, synchronization operations, cyclic redundancy check (CRC) operations, etc.) on behalf of virtual machine 118A and distributed HSM 112A. In accordance with an embodiment, secure accelerator 234 is configured to perform a secure operation on behalf of HSM 112A.

As discussed with respect to FIG. 2, key vault 126 of central HSM 102 stores keys on behalf of users of a cloud service. For example, key vault 126 stores a key 208. Key 208 is a key configured for performing cryptographic operations on behalf of a user associated with virtual machine 118A.

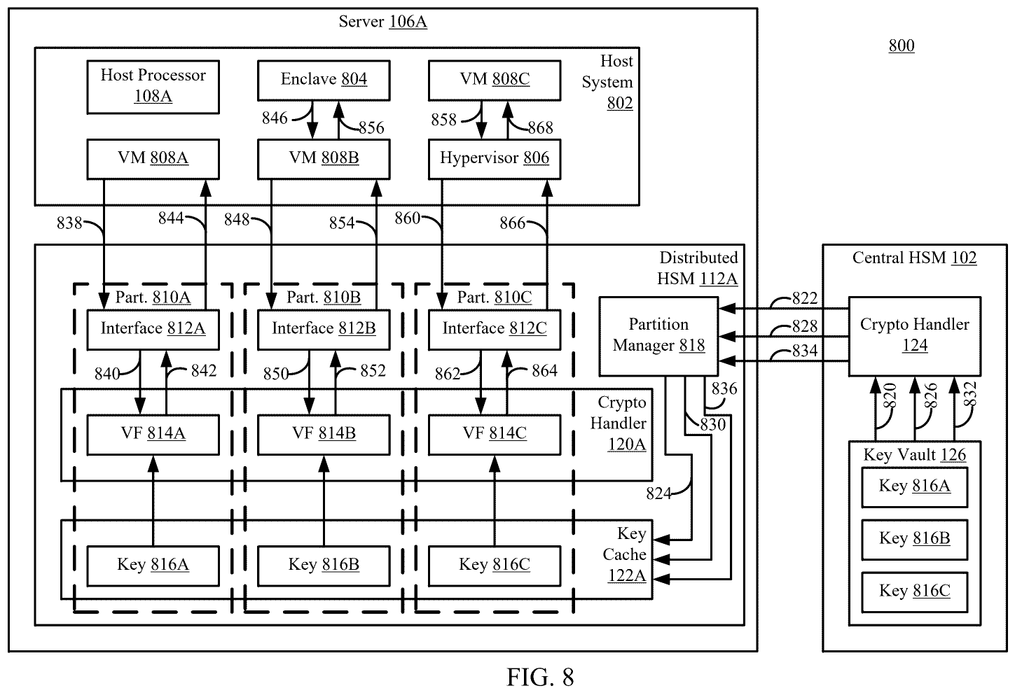

In accordance with an embodiment, key 208 comprises key metadata that restricts the usage of the key to certain functions/operations (e.g., certain secure operations). In some embodiments, the key metadata comprises a tag that prevents unauthorized use of the key. For instance, key metadata restricts use of key 208 to a particular operation type (e.g., encryption, decryption, signature verification, signing, sealing, unsealing, etc.), to a particular partition of HSM 112A (e.g., as described further with respect to FIG. 8), to a particular user account (e.g., a user account associated with virtual machine 118A and/or an application executing thereon), to a particular application, to a particular host server (e.g., server 106A), to a particular instance of a virtual machine (e.g., the instance of virtual machine 118A executing on server 106A), a particular timeframe (e.g., no sooner than a particular time and/or date, authorized usage expires at a particular time and/or date, and/or the like), and/or any other criterion for restricting use of key 208.

In an embodiment, crypto handler 120A establishes a secure link with a device external to HSM 112A. For instance, crypto handler 120A establishes communication link 240 with secure accelerator 234. Crypto handler 120A utilizes this link to transmit data to secure accelerator 234 for performing accelerated operations. For instance, in accordance with an embodiment, secure accelerator 234 is a secure data accelerator that securely manipulates, transfers, and/or modifies data. In some embodiments, crypto handler 120A releases a key to secure accelerator 234 for secure accelerator 234 to perform cryptographic operations utilizing the key. For instance, suppose secure accelerator 234 is a trusted cryptographic accelerator. In this example, HSM 112A is configured to provide secure accelerator 234 access to key 208 for performing cryptographic operations on behalf of HSM 112A. By utilizing communication link 240 to transmit data between HSM 112A and secure accelerator 234, HSM 112A is able to leverage accelerators of server 106A without exposing data (e.g., keys or secrets) to host memory of server 106A. In accordance with an embodiment, communication link 240 comprises a secure out-of-band channel between HSM 112A and secure accelerator 234. By having communication link 240 out-of-band, risk of tampering or interception by a malicious entity (e.g., malicious software or hardware) is reduced.

In some embodiments, security coprocessors 114A and 114N execute code to perform management path functions. Example management path functions include booting server 106 from rest (e.g., authenticating firmware of the respective HSM, authenticating firmware of the host, etc.), installing a configuration of the respective HSM (e.g., stored in non-volatile memory of the respective HSM), setting up a secure channel to a guest (e.g., setting up a secure channel to a virtual machine executed by the host processor, negotiating and exchanging a session base symmetric key with a guest, attesting a guest), and/or other functions associated with securely managing the respective HSM and the server it is implemented on. In some embodiments, security coprocessor 114A and/or 114N perform a management path function responsive to a support update to firmware of the HSM or host, an install run time configuration update, a request to allocate HSM resources (e.g., bandwidth of the HSM, a queue of the HSM, etc.), a request to set up a secure session, as part of the management life cycle of a secure session, a request to unwrap and/or install keys (and/or key attributes) in a respective key cache, a request to create a key blob utilizing a key stored in a respective key cache, a request to import and/or export a key, a request to provide a TPM function, and/or the like.

In some embodiments HSM 112A and/or HSM 112N is configured to perform data path functions. In some implementations, a data path function is performed by a respective security coprocessor (e.g., security coprocessor 114A and/or 114N) executing code. In an alternative implementation, a separate processor/circuitry of the HSM (e.g., a data path processor, an HSM coprocessor, an arithmetic logic unit, a register, an internal bus, etc., not shown in FIG. 1 for brevity) executes code to perform data path functions (e.g., independent of the respective security coprocessor). In this alternative, by executing data paths utilizing a separate processor, data path functions are performed with increased throughput and reduced latency. For instance, in accordance with an embodiment, HSM 112A provisions an encryption engine (e.g., an AES engine) to perform cryptographic operations. In this context, the encryption engine is provisioned with a key from key cache 122A and is able to perform cryptographic operations on behalf of a host/guest without requiring security coprocessor 114A to access keys. In accordance with an embodiment, the encryption engine receives cryptographic operation requests, provides cryptographic results and/or accesses data a cryptographic operation is to be performed on utilizing a fast-path connection.

Virtual machine 118A is executed by a host processor of server 106A (e.g., host processor 108A of FIG. 1) on behalf of a user. While only one virtual machine is shown in FIG. 2, server 106A may host many (e.g., ones, tens, hundreds, or greater) virtual machines. As shown in FIG. 2, virtual machine 118A comprises an operating system 202 (“OS 202” herein), an application 204, and an enclave 206. OS 202 is configured to execute applications (such as application 204) on behalf of a user. Application 204 enables a user to access data, perform operations, and/or leverage HSM 112A.

Enclave 206 is configured to protect and/or store sensitive data on behalf of virtual machine 118A. For instance, in some embodiments, enclave 206 manages communications between virtual machine 118A and HSM 112A. In accordance with an embodiment, enclave 206 is instantiated in virtual machine 118A. Alternatively, enclave 206 is a software enclave separate from virtual machine 118A (e.g., a virtual enclave implemented by the host that is hosting virtual machine 118A. In another alternative, enclave 206 is a hardware enclave separate from virtual machine 118A and the host processor (e.g., separate from host processor 108A).

In accordance with an embodiment, enclave 206 initiates a session with HSM 112A. For instance, in an example embodiment, enclave 206 detects or otherwise communicates with HSM 112A (e.g., as a process where enclave 206 attests devices of server 106A). In this context, HSM 112A provides a certificate of its authenticity, the certificate comprising a session key. In an embodiment, enclave 206 obtains an attestation certificates from other devices of server 106A (e.g., sensor 232, secure accelerator 234, accelerator 236, hardware interfaces, input/output devices, etc.). Enclave 206 generates a sealed package comprising the attestation certificates and encrypts the sealed package with the session key. HSM 112A receives the sealed package from enclave 206, thereby establishing a per-device link encryption key between HSM 112A and the device. Furthermore, enclave 206, HSM 112A, and/or a host system executing virtual machine 118A assign device utilization to a guest (e.g., virtual machine 118A or an application executing thereon). In this context, enclave 206 and/or HSM 112A are able to verify if the guest is allowed to utilize a device of server 106A based on the secure assignment.

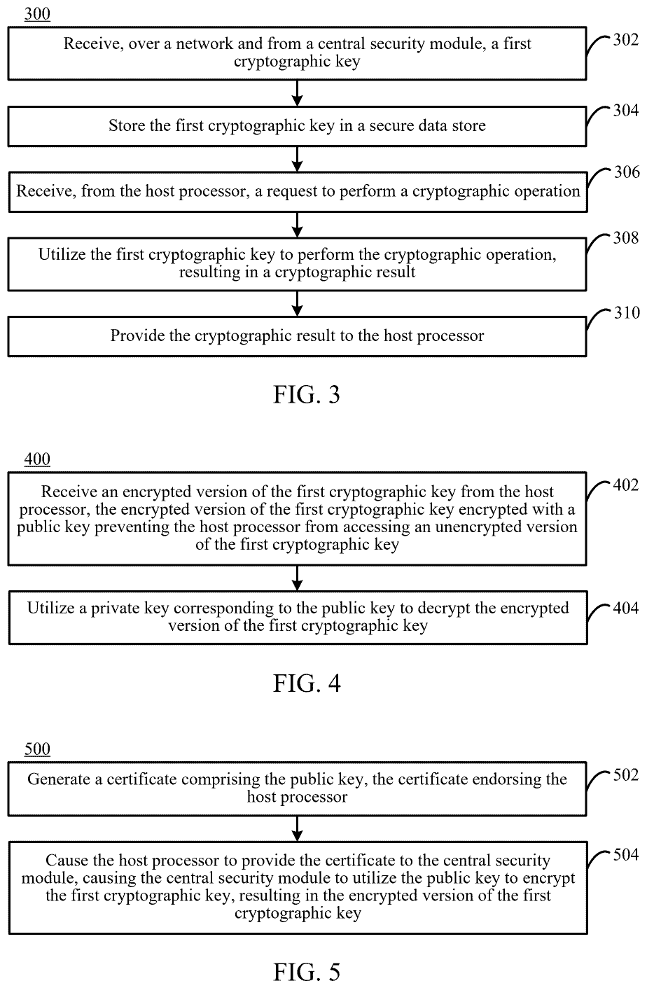

HSM 112A operates in various ways for secure key utilization, in embodiments. For example, FIG. 3 shows a flowchart 300 of a process for secure key utilization in a distributed hardware security module, in accordance with an example embodiment. In accordance with an embodiment, HSM 112A operates according to flowchart 300. Note that not all steps of flowchart 300 need be performed in all embodiments. Further structural and operational embodiments will be apparent to persons skilled in the relevant art(s) based on the following descriptions of FIGS. 2 and 3.

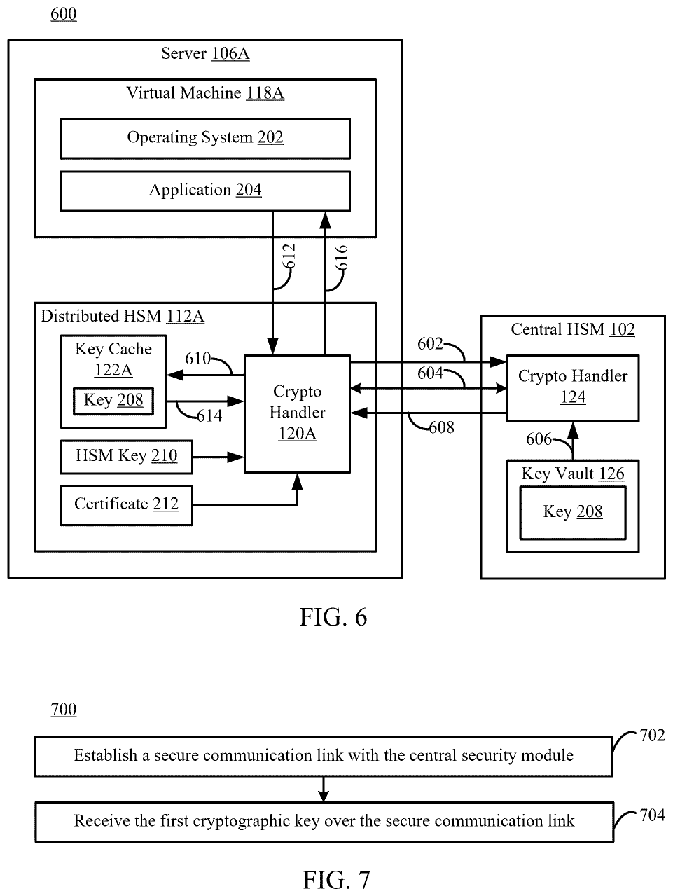

Flowchart 300 begins with step 302. In step 302, a first cryptographic key is received over a network and from a central security module. For example, crypto handler 120A receives key 208 from crypto handler 124 via response 222 from enclave 206. In this context, enclave 206 receives key 208 from crypto handler 124 via key response 220. In accordance with an embodiment, key 208 is encrypted with a public session key corresponding to a session between enclave 206 and HSM 112A. In this context, access to the key 208 is prevented except by HSM 112A, which possesses the corresponding private session key. For instance, suppose enclave 206 communicates with HSM 112A using a bounce buffer of virtual machine 118A. In this context, encrypting key 208 with a public session key prevents virtual machine 118A (or the host executing virtual machine 118A) from accessing an unencrypted version of key 208, reducing exposure of unencrypted versions of key 208. Furthermore, in some embodiments, and as described further with respect to FIGS. 4 and 5, key 208 is encrypted in a manner that prevents enclave 206 from accessing an unencrypted version of key 208. In some embodiments, and as described with respect to FIGS. 6 and 7, crypto handler 120A receives key 208 from crypto handler 124 without the use of an enclave.

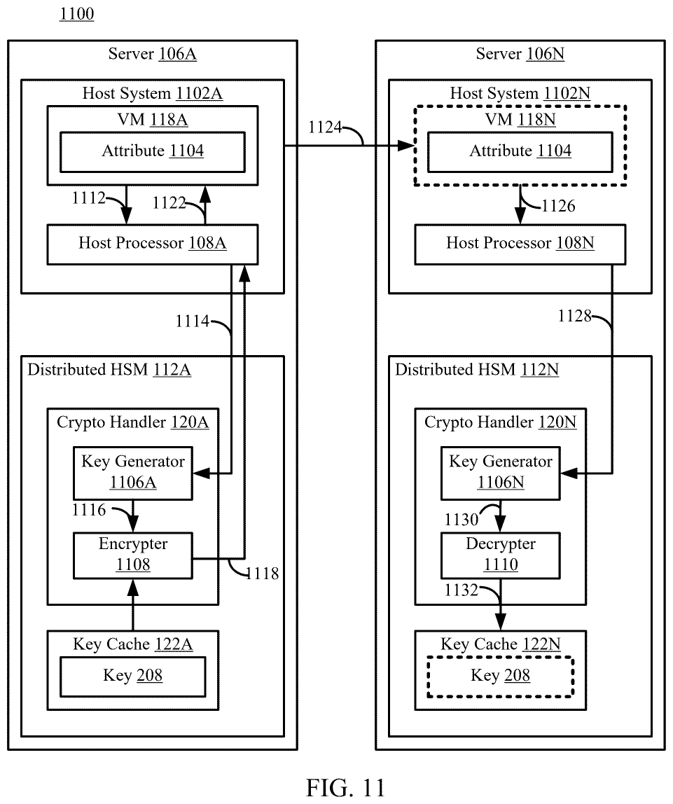

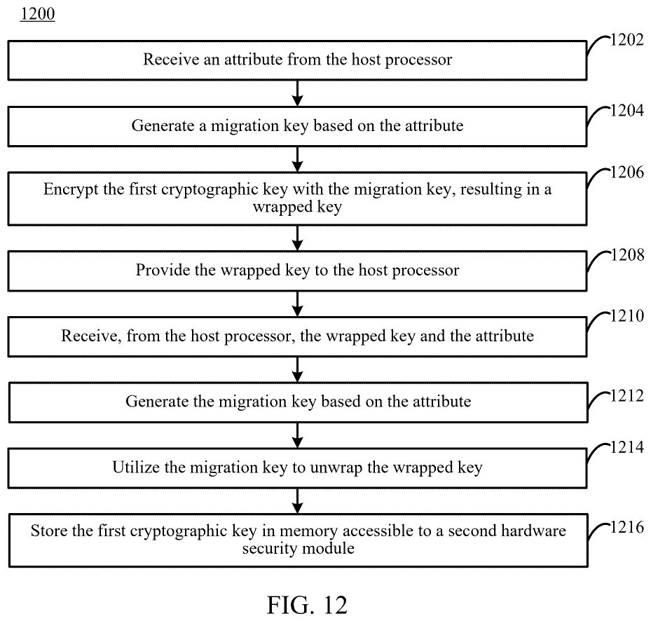

In accordance with an embodiment, key 208 comprises an indication (e.g., metadata) of whether or not key 208 is allowed to be exported to an authorized device. For instance, in an example, the indication indicates key 208 is not to be exported. In this context, HSM 112A prevents other hardware, software, and/or firmware external to HSM 112A from accessing or utilizing key 208. In another embodiment, the indication indicates key 208 is exportable to another HSM. In this context, HSM 112A exports key 208 (e.g., in a secure manner) to another HSM (e.g., HSM 112N of FIG. 1) for use thereby (e.g., in cases where keys are to be migrated from HSM 112A to the another HSM, e.g., as further described with respect to FIGS. 11 and 12, as well as elsewhere herein).

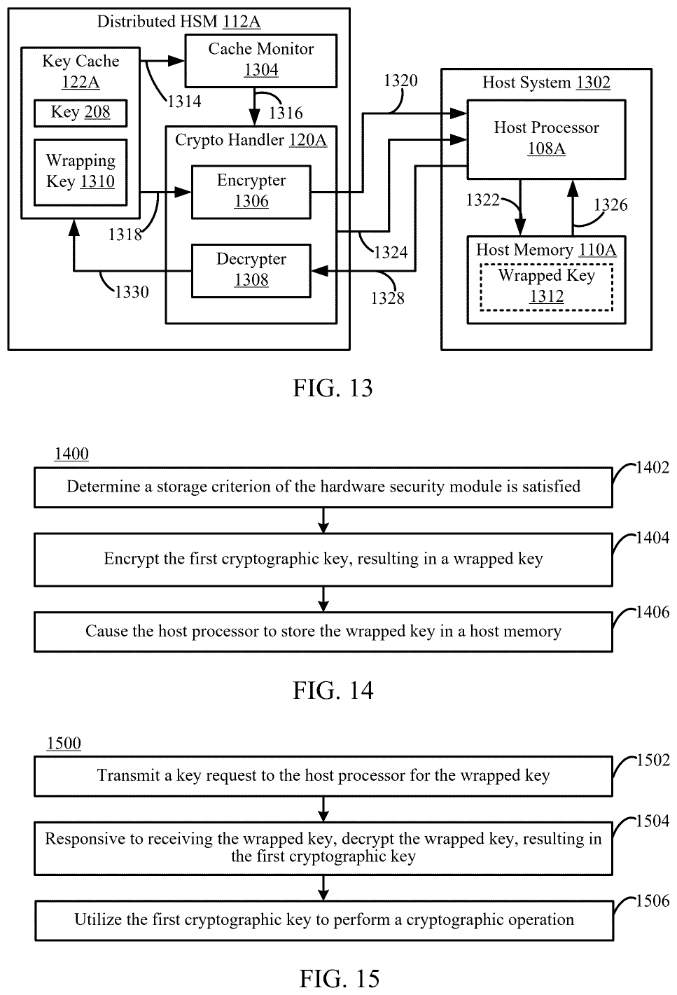

In step 304, the first cryptographic key is stored in a secure data store. For example, crypto handler 120A of FIG. 2 stores key 208 in key cache 122A via storage signal 224. In accordance with an embodiment, key 208 is stored with metadata indicating the type of operations it is allowed to be used for, whether or not it is exportable, and/or other restrictions or information associated with key 208. In accordance with an embodiment, the stored version of key 208 comprises metadata that restricts the usage of key 208 to a subset of operations and/or on behalf of a particular user, instance of a virtual machine (e.g., an instance of virtual machine 118A), instance of an application (e.g., an instance of application 204), hardware (e.g., host hardware executing virtual machine 118A), a session between enclave 206 and crypto handler 120A, and/or the like. Depending on the implementation, crypto handler 120A generates the metadata or the metadata is generated by crypto handler 124. Alternatively, the metadata is included in the version of key 208 stored in key vault 126 (i.e., thereby restricting usage of (e.g., any) instance of key 208). In accordance with an embodiment, key cache 122A is volatile memory such that, should HSM 112A lose power or be compromised, the memory is wiped, further preventing unauthorized access to key 208. In some cases, a storage capacity of key cache 122A is reached. In this context, and as further described with respect to FIGS. 13-15, HSM 112A securely stores encrypted versions of excess keys in host memory.

In step 306, a request to perform a cryptographic operation is received from the host processor. For example, crypto handler 120A of FIG. 2 receives request 226 to perform a cryptographic operation from the host processor (e.g., host processor 108A). In some cases, crypto handler 120A receives request 226 from an entity executed by host processor 108A. For instance, as shown in FIG. 2, crypto handler 120A receives request 226 from enclave 206 (e.g., on behalf of virtual machine 118A).

In an embodiment, crypto handler 120A receives request 226 by enclave 206 “ringing a doorbell” of HSM 112A indicating request 226 is ready for processing. In accordance with an embodiment, HSM 112A (or crypto handler 120A) places request 226 in a queue (not shown in FIG. 2 for brevity) (e.g., responsive to the doorbell of HSM 112A being rung). In embodiments, a request is prioritized based on the time it was received, based on a high prioritization indication, based on a low prioritization indication, based on a configuration of a user account associated with the request (e.g., requests received from a first user account are prioritized over requests received from a second user account), and/or the like. In some embodiments, a request is scheduled to a queue if the HSM (or its corresponding partition) has bandwidth to fulfill the request.

In accordance with an embodiment, request 226 is a request to perform a data path function. In this context, request 226 comprises a descriptor describing a location of data and a command to be performed with respect to the data. For instance, in an embodiment, request 226 comprises a physical region page (PRP) specifying a physical memory location of the data or a scatter gather list (SGL) specifying the physical memory location. In accordance with an embodiment, request 226 comprises a pointer to a list (e.g., a list that describes a plurality of PRP entries) or a segment (e.g., a (e.g., next) segment of a plurality of SGL segments) that describes a list of PRP entries. In an embodiment, crypto handler 120A utilizes a memory access engine (e.g., a direct memory access (DMA) engine) to read (and/or write) data.

While FIG. 2 illustrates crypto handler 120A receiving request 226 from enclave 206, embodiments described herein are not so limited. For instance, in another example further described with respect to FIG. 6, application 204 transmits a request to perform a cryptographic operation (e.g., directly (not via an enclave)) to HSM 112A. In another example, a buffer of virtual machine 118A acts as an intermediary between enclave 206 and crypto handler 120A.

In examples where request 226 is placed in a queue, the queue can be configured in various ways. For instance, in an example embodiment the queue is a circular buffer (e.g., with a fixed slot sized). In an example, pages in the queue are physically continuous. An example embodiment of HSM 112A comprises a submission queue and a completion queue. The submission queue is utilized for storing received requests and the completion queue is utilized for storing completion messages (and/or other responses). In embodiments, a completion message indicates a request is completed/fulfilled. The submission queue (and/or the completion queue) may be allocated to a particular virtual function, physical function, host, guest, and/or the like. For instance, in an implementation, a first submission queue and a first completion queue are mapped to virtual machine 118A (or a component thereof) and a second submission queue and a second completion queue are mapped to another virtual machine executed by server 106A, not shown in FIG. 2. In this context, a particular submission queue (e.g., only) accepts requests from the requestor it is mapped to and the corresponding completion queue (e.g., only) provides responses to the mapped requestor. In an embodiment, the queue (or another component of HSM 112A) comprises logic for determining whether or not the request is from the correct requestor (e.g., based on an identifier included in the request).

Examples of submission queues and completion queues have been described as being stored in memory of HSM 112A. However, in some embodiments, the queue is stored within host memory (e.g., host memory 110A of FIG. 1). In this context, a request received by crypto handler 120A comprises a pointer to the submission's location in the queue and causes crypto handler 120A to access the submission. In this context, request 226 can be relatively small (e.g., includes (e.g., only) the pointer and/or the originating requestor (e.g., enclave 206)) with additional information included in the submission. For example, the submission includes information such as, but not limited to, an endpoint identifier that uniquely identifies the requestor (e.g., a process address space ID (PASID)), a command identifier (CID) that specifies a communication protocol command (e.g., a nonvolatile memory express (NVMe) command), a command type (e.g., encrypt, decrypt, etc.), a source pointer type, destination pointer type, an auxiliary command pointer pointing to an auxiliary command address, a source data pointer pointing to a location at which data is stored, a length of the source data, a destination data pointer pointing to a location which data (e.g., a cryptographic result) is to be stored, a length of the destination data, a cipher to be used for performing a cryptographic operation, a flag, a key index of a key in key cache 122A to be used, and/or the any other information associated with the cryptographic operation to be performed, the requestor requesting the cryptographic operation, and/or secure communication protocols between the requestor and HSM 112A.

As mentioned above (and elsewhere herein), in some implementations, request 226 (or a preceding request) comprises a “ring of a doorbell”. A doorbell is mapped to a register (e.g., a PCIe base address register (BAR)) that describes a memory region of HSM 112A. In accordance with an embodiment, the doorbell ring comprises a target submission identifier that uniquely identifies a request to be fulfilled (e.g., request 226). In an embodiment, HSM 112A enforces access policies responsive to the doorbell ring. For instance, HSM 112A determines whether or not the doorbell ring originated from an authorized guest/host. If so, flow continues to step 308. If not, the request is rejected.

In step 308, the first cryptographic key is utilized to perform the cryptographic operation, resulting in a cryptographic result. For example, crypto handler 120A utilizes key 208 to perform the cryptographic operation, resulting in a cryptographic result. In embodiments, crypto handler 120A obtains key 208 from key cache 122A (e.g., via a key signal 228). Crypto handler 120A reads data indicated in request 226 over a communication link to the location of the data (e.g., data stored in memory of server 106A, data stored by virtual machine 118A, data over a connection between server 106A and an external memory device). Alternatively, the data is included in request 226. Crypto handler 120A utilizes key 208 to perform the cryptographic operation with respect to the data (e.g., by decrypting the data, encrypting the data, signing the data, verifying a signature of the data, and/or performing another type of cryptographic operation with respect to the data). The cryptographic operation results in a cryptographic result. In an implementation, crypto handler 120A sets up an engine (e.g., an encryption engine) to perform the cryptographic operation on behalf of crypto handler 120A. In this context, crypto handler 120A obtains key 208 and causes the engine to perform the cryptographic operation using key 208.

In step 310, the cryptographic result is provided to the host processor. For example, as shown in FIG. 2, crypto handler 120A provides a completion signal 230 to enclave 206. In an embodiment, completion signal 230 comprises the cryptographic result from step 308. In another embodiment, completion signal 230 comprises an indication (e.g., a notification, a completion message, etc.) that the cryptographic operation was performed. For instance, in an embodiment, crypto handler 120A writes the cryptographic result to memory and notifies enclave 206 that request 226 was successful. In accordance with an embodiment where the cryptographic operation was unsuccessful, completion signal 230 indicates the cryptographic operation was unsuccessful. In this context, completion signal 230 causes enclave 206 to reissue request 226, flag an error, prompt an error to a user computing device, and/or the like. In accordance with an embodiment, crypto handler 120A (or HSM 112A) utilizes a memory access engine to write the cryptographic result to host memory.

In accordance with an embodiment, crypto handler 120A combines multiple cryptographic results into a single completion signal 230. For instance, in an implementation utilizing PCIe communication, crypto handler 120A combines multiple cryptographic results into a single PCIe write signal. In this context, crypto handler 120A improves PCIe utilization and memory utilization of the host. In accordance with an embodiment, crypto handler 120A comprises a timer for writing combined cryptographic results. In this context, crypto handler 120A transmits completion signal 230 comprising multiple cryptographic results when the size of the completion signal satisfies a threshold (e.g., the size of the completion signal is within a predetermined number of bits of a maximum size of the completion signal) or when the timer expires. By utilizing a timer, crypto handler 120A avoids waiting too long to provide a cryptographic result if the size of completion signal 230 does not satisfy the threshold.

In accordance with an embodiment, crypto handler 120A writes cryptographic results (or a group of cryptographic results) to a queue. The queue is maintained by HSM 112A or host memory 110A. In an example, the queue (also referred to as a “completion queue” is associated with the same virtual function or physical function as the submission queue that request 226 corresponds to. In an example where the completion queue is uniquely mapped to a single interrupt, the single interrupt implicitly identifies the completion queue. An entry in the completion queue comprises data such as, but not limited to, a command identifier of the command performed (e.g., the same command identifier that was included in the corresponding submission of the submission queue), an identifier of the corresponding submission queue, the tail of the submission queue, a command type, the command, the length of data to be written to the destination buffer (e.g., the destination buffer indicated in the corresponding submission), a status code, an error code, a phase bit, and/or any other information or data associated with the completion of the cryptographic operation, the destination to which the result is to be written to, and/or the requestor.

HSM 112A is configured to receive and utilize a cryptographic key in various ways. For instance, as shown in FIG. 2, HSM 112A receives cryptographic key from enclave 206 (e.g., executed by or on behalf of host processor 110A). FIG. 4 shows a flowchart 400 of a process for receiving a cryptographic key, in accordance with an example embodiment. In accordance with an embodiment, HSM 112A operates according to flowchart 400. Note that not all steps of flowchart 400 need be performed in all embodiments. Further structural and operational embodiments will be apparent to persons skilled in the relevant art(s) based on the following description of FIG. 4 with respect to FIG. 2.

Flowchart 400 begins with step 402. In step 402, an encrypted version of the first cryptographic key is received from the host processor, the encrypted version of the first cryptographic key encrypted with a public key preventing the host processor from accessing an unencrypted version of the first cryptographic key. For example, crypto handler 120A receives a response 222 comprising an encrypted version of key 208, the encrypted version of the first cryptographic key encrypted with a public key of HSM key 210 and preventing host processor 108A (or any other device or service without the private key of HSM key 210) from accessing an unencrypted version of key 208. In accordance with an embodiment, enclave 206 receives the encrypted version of key 208 from central HSM 102 as a wrapped key wrapped with a public key of enclave 206. In this context, prior to providing the encrypted version of key 208 to HSM 112A, enclave 206 utilizes a private key of enclave 206 to unwrap the wrapped key, resulting in the encrypted version of key 208. In an embodiment, the encrypted version of the key 208 is received as an encrypted key wrap blob. In accordance with an embodiment, the encrypted key wrap blob comprises metadata restricting the usage of key 208.

In step 404, a private key is utilized to decrypt the encrypted version of the first cryptographic key, the private key corresponding to the public key that was used to encrypt the encrypted version of the first cryptographic key. For example, crypto handler 120A utilizes a private HSM key of HSM key 210 to decrypt the encrypted version of key 208 included in response 222. As shown in FIG. 2, crypto handler 120A stores key 208 in key cache 122A, as described with respect to step 304 of flowchart 300 of FIG. 3.

HSM 112A of FIG. 2 operates in various ways to utilize a host processor of server 106 to receive cryptographic keys from central HSM 102. For example, FIG. 5 shows a flowchart 500 of a process for requesting a cryptographic key, in accordance with an example embodiment. In accordance with an embodiment, HSM 112A operates according to flowchart 500. Note that not all steps of flowchart 500 need be performed in all embodiments. Further structural and operational embodiments will be apparent to persons skilled in the relevant art(s) based on the following description of FIG. 5 with respect to FIG. 2.

Flowchart 500 begins with step 502. In step 502, a certificate comprising the public key is generated, the certificate endorsing the host processor. For example, crypto handler 120A of FIG. 2 generates certificate 212 responsive to receiving a session request (not shown in FIG. 2 for brevity) from enclave 206. The session request comprises a request to establish a session between enclave 206 and HSM 112A. HSM 112A generates certificate 212 comprising a public key of HSM key 210 (e.g., where HSM key 210 comprises a public HSM key and a private HSM key). HSM 112A utilizes a signing key of HSM 112A to sign the certificate, thereby endorsing the host processor. In accordance with an embodiment, the signature also endorses host firmware, virtual machine 118A, OS 202, application 204, enclave 206, and/or other components of server 106A and/or services executed by components of server 106A, and/or measurements made by HSM 112A.

In some embodiments, HSM 112A and enclave 206 exchange keys as part of establishing a session between enclave 206 and HSM 112A. For example, suppose the session request from enclave 206 (not shown in FIG. 2 for brevity) comprises a public enclave key of enclave 206. In this context, enclave 206 sets the corresponding private enclave key private to enclave 206. HSM 112A provides a public key (e.g., a public key of HSM key 210) to enclave 206. HSM 112A and enclave 206 utilize corresponding public keys of the other to encrypt messages/signals between the two.

In step 504, the host processor is caused to provide the certificate to the central security module, causing the central security module to utilize the public key to encrypt the first cryptographic key, resulting in the encrypted version of the first cryptographic key. For instance, crypto handler 120A provides certificate signal 214 (which comprises certificate 212) to enclave 206. Enclave 206 provides certificate 212 to crypto handler 124 of central HSM 102 via key request 216. In some embodiments, enclave 206 generates an enclave certificate that endorses the system on behalf of the enclave and includes the enclave certificate in key request 216. In accordance with an embodiment, enclave 206 signs the enclave certificate using an enclave signing key. Crypto handler 124 obtains the public key of HSM key 210 from certificate 212. In accordance with an embodiment, crypto handler 124 verifies the signature(s) of certificate 212 and/or the enclave certificate utilizing corresponding verification key(s) (e.g., prior to utilizing the public key of HSM key 210 included in the certificate). Crypto handler 124 and obtains key 208 from key vault 126 via key signal 218. In accordance with an embodiment, certificate 212 (and/or key request 216) comprises identifying information of key 208, e.g., a user account corresponding to key 208, a location in which key 208 is stored, a policy associated with key 208, and/or the like. Crypto handler 124 utilizes the public key of HSM key 210 to encrypt key 208, and provides the encrypted version of key 208 to enclave 206 as key response 220. In accordance with an embodiment wherein key request 216 included the enclave certificate, crypto handler 124 double seals the key 208 to enclave 206 and HSM 112A by further wrapping the encrypted version of key 208 with a public key of enclave 206. In this context, (e.g., only) enclave 206 is able to access an unwrapped version of the encrypted version of key 208 (e.g., utilizing a private key of enclave 206). In embodiments, flow continues in a similar manner as described with respect to flowchart 400 of FIG. 4.

In an embodiment, crypto handler 124 double wraps the key by wrapping the encrypted version of key 208 with a public key corresponding to a private key of enclave 206 (also referred to as a “public enclave key” herein). In this context, (e.g., only) enclave 206 is able to unwrap the first layer of the double-wrapped key, further protecting the decrypted version of key 208 from man-in-the-middle attacks. In accordance with an embodiment, the public enclave key is included in key request 216.

Embodiments of an HSM of a server have been described with respect to FIG. 2 as communicating with an enclave of a guest/host (e.g., enclave 206 of FIG. 2); however, embodiments described herein are not so limited. For instance, HSM 112A, in some embodiments, communicates with a guest/host and/or central HSM 102 without the use of an enclave. In this context, a host/guest utilizes fewer compute resources, as security processes are managed by HSM 112A (e.g., and not an enclave of the guest/host). Furthermore, a user is not required to trust an enclave or treat the enclave as a trusted entity, thereby reducing the different entities within a root of trust. Embodiments of HSMs operating in systems without enclaves (or in a system that has an enclave but does not require the enclave for use of the HSM) can be configured in various ways, in embodiments. For instance, FIG. 6 shows a block diagram of another example system 600 for secure key utilization in a distributed hardware security module, in accordance with another example embodiment. As shown in FIG. 6, system 600 comprises central HSM 102 (comprising crypto handler 124 and key vault 126 (storing key 208)) and server 106A (comprising virtual machine 118A (comprising OS 202 and application 204) and HSM 112A (comprising crypto handler 120A, key cache 122A (storing key 208), HSM key 210, and certificate 212)), as described with respect to FIG. 2.

As shown in FIG. 6, virtual machine 118A does not include an enclave. In embodiments, HSM 112A obtains cryptographic keys from central HSM 102 without the use of an enclave. In some embodiments, virtual machine 118A (or server 106A, or another component of server 106A) comprises an enclave that is not utilized by HSM 112A for obtaining keys from central HSM 102. To better understand the operation of HSM 112A of system 600, FIG. 6 is described with respect to FIG. 7. FIG. 7 shows a flowchart 700 of another process for receiving a cryptographic key, in accordance with another example embodiment. In accordance with an embodiment, HSM 112A operates according to flowchart 700. Note that not all steps of flowchart 700 need be performed in all embodiments. Further structural and operational embodiments will be apparent to persons skilled in the relevant art(s) based on the following descriptions of FIGS. 6 and 7.

Flowchart 700 begins with step 702. In step 702, a secure communication link is established with the central security module. For example, crypto handler 120A of FIG. 6 establishes a secure communication link 604 (“communication link 604” herein) by transmitting a link request 602. In accordance with an embodiment, link request 602 comprises a unique identifier of HSM 112A. For instance, in accordance with an embodiment, link request 602 comprises certificate 212 attesting the authenticity of HSM 112A. In accordance with an embodiment, link request 602 comprises a request for key 208 and, optionally, a public encryption key for encrypting key 208 (e.g., in a similar manner as described with respect to flowchart 500 of FIG. 5. In embodiments, link request 602 comprises tenant and/or user identifiers that uniquely identify the accounts for which HSM 112A requires cryptographic keys. For instance, with respect to FIG. 6, link request 602 comprises an identifier that uniquely identifies a tenant account associated with virtual machine 118A and to which key 208 is assigned. While link request 602 is illustrated using a single line between crypto handler 120A and crypto handler 124, in some embodiments, link request 602 comprises multiple signals, e.g., multiple signals from crypto handler 120A or multiple back-and-forth signals between crypto handler 120A and crypto handler 124 (e.g., as part of a handshake process).

Flowchart 700 continues to step 704, which is a further example of step 302 of flowchart 300 of FIG. 3. In step 704, the first cryptographic key is received over the secure communication link. For example, crypto handler 120A receives key 208 as response 608 over communication link 604. In accordance with an embodiment, crypto handler 124 accesses key vault 126 responsive to link request 602 (or a subsequent key request) to obtain key 208 via a key signal 606. Crypto handler 124 transmits key 208 to crypto handler 120A as response 608. In accordance with an embodiment, crypto handler 124 encrypts key 208 with a public key of HSM key 210 to prevent a “man-in-the-middle” attack from accessing the unencrypted version of key 208.

Flowchart 700 continues in a similar manner as described with respect to steps 304-310 of flowchart 300 of FIG. 3. For example, crypto handler 120A stores key 208 in key cache 122A via storage signal 610. Crypto handler 120A receives a request 612 from application 204. Request 612 is a request to perform a cryptographic operation, as described with respect to request 226. Crypto handler 120A obtains key 208 via key signal 614 and utilizes key 208 to perform the requested cryptographic operation, resulting in a cryptographic result. As shown in FIG. 6, crypto handler 120A provides the cryptographic result to application 204 via response 616. In some embodiments, response 616 comprises an indication that the cryptographic operation is completed (e.g., as an alternative to cryptographic result). By acquiring keys without the use of an enclave, HSM 112A does not have to rely on a user's computing resources to establish a link between HSM 112A and central HSM 102. This frees the user's computing resources for other tasks, and simplifies the root of trust, as (e.g., only) the central HSM and HSM 112A need to be trusted to handle keys.

Embodiments of HSMs have been described with respect to FIGS. 2-7 as receiving keys (e.g., key 208) from a central HSM (e.g., central HSM 102). In an alternative embodiment, HSM 112A receives a key from a centralized key vault (e.g., a key vault other than central HSM 102). In accordance with another embodiment, HSM 112A receives key material from central HSM 102. Examples of key material include, but are not limited to, attributes of a system, attributes of a user account, attributes of a cloud service provider, e.g., attributes of central HSM 102, generated bits of data, a secret, and/or any other type of material usable for generating a key. In this context, crypto handler 120 of HSM 112A generates a key based on the received key material. By generating a key in this way, the key is not exposed via communication between HSM 112A and central HSM 102. Furthermore, in this context, central HSM 102 does not have access to the generated key (even in encrypted form). This reduces the amount of data central HSM 102 has to store and removes central HSM 102 from a circle of trust (e.g., a user does not have to trust that keys generated by central HSM 102 are authentic, as central HSM 102 did not generate the key).

### III. Example Embodiments Utilizing a Partitioned Distributed Hardware Module

In some embodiments, an HSM on a server supports multiple guests. In this context, the HSM isolates operations associated with different guests or groups of guests by partitioning interfaces and/or cryptographic functions. Embodiments of HSMs with partitioning capabilities are configurable in various ways. For instance, FIG. 8 shows a block diagram of example system 800 for secure key utilization in a partitioned distributed hardware security module, in accordance with example embodiment. As shown in FIG. 8, system 800 comprises central HSM 102 (comprising crypto handler 124 and key vault 126) and server 106A, as described with respect to FIG. 1. As also shown in FIG. 8, key vault 126 stores a first key 816A, a second key 816B, and a third key 816C, each corresponding to a different tenant of a cloud service.

Server 106A comprises a host system 802 and distributed HSM 112A (as described with respect to FIG. 1). Host system 802 is an example of host processor 108A and host memory 110A, as described with respect to FIG. 1. As shown in FIG. 8, host system 802 comprises host processor 108A, an enclave 804, a hypervisor 806, and virtual machines 808A-808C. Enclave 804 is an example of enclave 206, in an embodiment. Virtual machines 808A-808C are examples of virtual machine 118A. Each of virtual machines 808A-808C are associated with a different user (or tenant) of a cloud service. In this context, host system 802 provides services of the cloud service to multiple users simultaneously. Hypervisor 806 is configured to create, manage, and/or otherwise support virtual machine 118C. As shown in FIG. 8, virtual machine 808B acts as an intermediary between enclave 804 and HSM 112A. Alternatively, enclave 804 is an intermediary between virtual machine 808B and HSM 112A.

In an embodiment, any of virtual machines 808A-808C comprise a confidential virtual machine. For instance, as a non-limiting example, virtual machine 808A comprises a hardware virtual machine that utilizes hardware encrypted interfaces, virtual machine 808B comprises a regular virtual machine, and virtual machine 808C comprises a hardware backed confidential virtual machine that utilizes a (e.g., unsecured) shared memory buffer to access an interface. In this context, virtual machine 800A is able to interact directly with HSM 112A utilizing hardware encrypted interfaces, virtual machine 800B utilizes enclave 804 to handle sensitive information (e.g., in a similar manner as described with respect to enclave 206 of FIG. 2), and virtual machine 808C utilizes a software-based encrypted channel (e.g., via hypervisor 806) over a secure processor path to communicate with HSM 112A.

HSM 112A of FIG. 8 comprises interfaces 812A-812C, crypto handler 120A (comprising virtual functions 814A-814C), key cache 122A (storing (e.g., copies of) keys 816A-816C), and a partition manager 818. Interfaces 812A-812C are configured to receive and transmit signals from HSM 112A to a guest hosted by host system 802 (e.g., virtual machines 808A-808C, enclave 804, and/or hypervisor 806). Examples of interfaces 812A-812C include, but are not limited to, serial peripheral interfaces (SPIs) (e.g., SPI flash interfaces (SPIFIs), Quad SPI (QSPIs), SPI filter interfaces), inter-integrated circuit (I2C) interfaces, universal asynchronous receiver/transmitter (UART) interfaces, serial wire debug (SWD) interfaces, general purpose input/output (GPIO) interfaces (e.g., secure GPIO interfaces), PCIe interfaces, and/or the like. In an example embodiment, a GPIO interface is configured to interrupt host processor 108A when there is a change in state. In a further embodiment, the interrupt is masked. Embodiments of interfaces 812A-812C include one or more security or communication features, including, but not limited to, interface filtering (e.g., for protecting external processors), separate memory access requests for master and slave monitoring functions, noise filtering on clock cycles, clock stretching, multi-master operations, boot watchdog timer (e.g., a timer that internally resets the boot process if not loaded during a boot time window (e.g., a window with a hysteresis extending time across the last watchdog timer reset), a watchdog timer that persists across watchdog resets, a timer that utilizes a flag to determine a boot source, and/or the like), an interrupt controller, I/O virtualization (e.g., including defense against I/O based address remapping attacks).

Virtual functions 814A-814C are virtualized instances of physical functions of crypto handler 120A (or another component of HSM 112A). In accordance with an embodiment, one or more of virtual functions 814A-814C are exposed to an operating system of a corresponding guest of host system 802 such that the guest is able to transmit requests to the virtual function and cause the virtual function to perform an operation. For instance, virtual function 814A is exposed to an operation system of virtual machine 808A, virtual function 814B is exposed to an operating system of virtual machine 808B, and virtual function 814C is exposed to an operating system of virtual machine 808C, in an embodiment.

Partition manager 818 is configured to partition HSM 112A to support multiple guests in a secure manner. For instance, as shown in FIG. 8, partition manager 818 operates to partition interface 812A, virtual function 814A, and key 816A into a partition 810A, to partition interface 812B, virtual function 814B, and key 816B into a partition 810B, and to partition interface 812C, virtual function 814C, and key 816C into a partition 810C. While FIG. 8 illustrates HSM 112A partitioned into three partitions, embodiments of distributed HSMs may be partitioned in a variety of manners. For instance, a distributed HSM may be partitioned into two partitions, three partitions, greater than three partitions, tens of partitions, hundreds of partitions, or even greater. In accordance with an embodiment, a distributed HSM is partitioned for each tenant that server 106 provides services for.

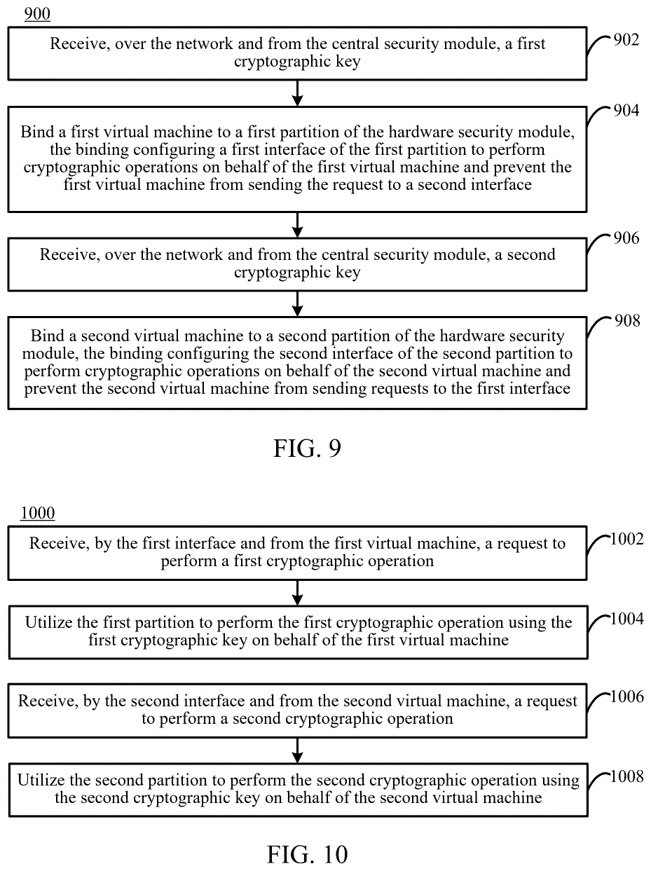

To better understand a partitioning process of HSM 112A comprising partition manager 818, FIG. 8 is described with respect to FIGS. 9 and 10. For instance, FIG. 9 shows a flowchart 900 of a process for partitioning a distributed hardware security module, in accordance with an example embodiment. In accordance with an embodiment, HSM 112A operates according to flowchart 900. Note that not all steps of flowchart 900 need be performed in all embodiments. Further structural and operational embodiments will be apparent to persons skilled in the relevant art(s) based on the following descriptions of FIGS. 8 and 9.

Flowchart 900 begins with step 902. In embodiments, step 902 is an example of step 302 of flowchart 300 or step 704 of flowchart 700, as respectively described with respect to FIGS. 3 and 7. In step 902, a first cryptographic key is received over a network and from a central security module. For example, partition manager 818 of FIG. 8 receives key 816A from crypto handler 124 in a key response 822. In accordance with an embodiment, partition manager 818 receives key response 822 as a response to establishing a link to crypto handler 124 (e.g., in a similar manner as described with respect to FIG. 7). In another embodiment, partition manager 818 receives key response 822 through host system 802 (e.g., in a similar manner as described with respect to FIG. 2). For instance, partition manager 818 receives key 816A from (e.g., confidential) virtual machine 808A, which received key 816A from crypto handler 124.

In step 904, a first virtual machine is bound to a first partition of the hardware security module, the binding configuring a first interface of the first partition to perform cryptographic operations on behalf of the first virtual machine and preventing the first virtual machine from sending the request to a second interface. For example, partition manager 818 partitions interface 812A, virtual function 814A, and a portion of key cache 122A (for storing key 816A) as partition 810A. In this context, partition manager 818 binds virtual machine 808A to partition 810A such that 812A accepts requests from virtual machine 808A (and not other virtual machines of host system 802, e.g., virtual machine 808B and virtual machine 808C) and/or an application on behalf of virtual machine 808A (e.g., an application executed by virtual machine 808A, not shown in FIG. 8 for brevity). Furthermore, in an example, the binding prevents virtual machine 808A from transmitting requests to other partitions of HSM 112A.

In step 906, a second cryptographic key is received over the network and from the central security module. For example, partition manager 818 of FIG. 8 receives key 816B from crypto handler 124 in a key response 828. In accordance with an embodiment, partition manager 818 receives key response 828 as a response to establishing a link to crypto handler 124 (e.g., in a similar manner as described with respect to FIG. 7). In accordance with an embodiment, partition manager 818 receives key 816B in the same response as key 816A (e.g., key response 822). In another embodiment, partition manager 818 receives key response 828 through host system 802 (e.g., in a similar manner as described with respect to FIG. 2). For instance, partition manager 818 receives key 816B from enclave 804 (e.g., with a buffer of virtual machine 808B as an intermediary), which received key 816A from crypto handler 124.

In step 908, a second virtual machine is bound to a second partition of the hardware security module, the binding configuring the second interface of the second partition to perform cryptographic operations on behalf of the second virtual machine and prevent the second virtual machine from sending requests to the first interface. For example, partition manager 818 partitions interface 812B, virtual function 814B, and a portion of key cache 122B (for storing key 816B) as partition 810B. In this context, partition manager 818 binds virtual machine 808B to partition 810B such that interface 812B accepts requests from enclave 804, virtual machine 808B, and/or an application executed by virtual machine 808B (and not other virtual machines of host system 802, e.g., virtual machine 808B and virtual machine 808C). Furthermore, in an example, enclave 804 and virtual machine 808B are prevented from sending requests to other partitions of HSM 112A.

As shown in FIG. 8, HSM 112A comprises a third partition, partition 810C. Partition manager 818 partitions partition 810C in a similar manner as partitions 810A and 810B. For instance, partition manager 818 receives a key 816C (e.g., as a key response 834 from crypto handler 124, as a set of keys including keys 816A-816C from crypto handler 124, as a response from virtual machine 808C (which received the key from crypto handler 124), and/or the like) and partitions interface 812C, virtual function 814C, and a portion of key cache 122A (for storing key 816C) as partition 810C. Virtual machine 808C and hypervisor 806 are bound to partition 810C, in embodiments. By partitioning HSM 112A into multiple partitions, each configured to provide secure key utilization for a different user or tenant, embodiments of system 800 improve device utilization (e.g., as bandwidth of HSM 112A is able to be utilized by other tenants when one tenant is not using the device) without compromising a security system's integrity in maintaining boundaries between secrets of different users and/or tenants.

HSM 112A of FIG. 8 operates in various ways to provide secure key utilization for multiple users/tenants. For instance, FIG. 10 shows a flowchart 1000 of a process for secure key utilization in a partitioned distributed hardware security module, in accordance with example embodiment. In accordance with an embodiment, HSM 112A operates according to flowchart 1000. Note that not all steps of flowchart 1000 need be performed in all embodiments. Further structural and operational embodiments will be apparent to persons skilled in the relevant art(s) based on the following description of FIG. 10 with respect to FIG. 8.

Flowchart 1000 begins with step 1002. Step 1002 is a further example of step 306, as described with respect to flowchart 300 of FIG. 3. In step 1002, a request to perform a first cryptographic operation is received by the first interface and from the first virtual machine. For example, interface 812A receives a request 838 from virtual machine 808A. Request 838 is a further example of request 226 of FIG. 2, in an embodiment. In embodiments, request 838 comprises a request to perform a cryptographic operation and/or a doorbell ring pointing to a submission in a queue, as described elsewhere herein.

Flowchart 1000 continues with step 1004, which is a further example of step 308, as described with respect to flowchart 300 of FIG. 3. In step 1004, the first partition is utilized to perform the first cryptographic operation using the first cryptographic key on behalf of the first virtual machine. For example, partition 810A operates to perform a cryptographic operation using key 816A on behalf of virtual machine 808A. As shown in FIG. 8, interface 812A forwards request 838 to virtual function 814A as operation request 840. Virtual function 814A utilizes key 816A to perform the cryptographic operation and provides cryptographic result 842 to interface 812A. Depending on the implementation, interface 812A provides cryptographic result 842 to virtual machine 808A via response 844, provides an indication that the cryptographic operation is complete to virtual machine 808A via response 844, and/or writes cryptographic result 842 to host memory of host system 802 (e.g., host memory accessible to virtual machine 808A).

In step 1006, a request to perform a second cryptographic operation is received by the second interface and from the second virtual machine. For example, interface 812B receives a request 848 from virtual machine 808B. In some embodiments, request 848 is a forward of request 846 from enclave 804. Request 848 is a further example of request 226 of FIG. 2, in an embodiment. In embodiments, request 848 comprises a request to perform a cryptographic operation and/or a doorbell ring pointing to a submission in a queue, as described elsewhere herein.

In step 1008, the second partition is utilized to perform the second cryptographic operation using the second cryptographic key on behalf of the second virtual machine. For example, partition 810B operates to perform a cryptographic operation using key 816B on behalf of virtual machine 808B and/or enclave 804. As shown in FIG. 8, interface 812B forwards request 848 to virtual function 814B as operation request 850. Virtual function 814B utilizes key 816B to perform the cryptographic operation and provides cryptographic result 852 to interface 812B. Depending on the implementation, interface 812B provides cryptographic result 852 to virtual machine 808B via response 854 (which, in an embodiment, causes virtual machine 808B to provide the cryptographic result to enclave 804 via response 856), provides an indication that the cryptographic operation is complete to virtual machine 808B via response 854 (which, in an embodiment, causes virtual machine 808B to provide an indication that the cryptographic operation is complete to enclave 804 via response 856), and/or writes cryptographic result 852 to host memory of host system 802 (e.g., host memory accessible to virtual machine 808B and/or enclave 804).

Partition 810C receives requests and performs cryptographic operations in a similar manner as described with respect to partitions 810A and 810B. For instance, partition 810C, in an embodiment and as shown in FIG. 8, receives a request 860 from hypervisor 806. Request 860 is a forward of request 858 from virtual machine 808C. In an embodiment, request 860 is a further embodiment of request 226 as described with respect to FIG. 2. Interface 812C forwards request 860 to virtual function 814C as an operation request 862, which causes virtual function 814C to utilize key 816C to perform the requested cryptographic operation. Virtual function 814C provides cryptographic result 864 to interface 812C. Depending on the implementation, interface 812C provides cryptographic result 864 to hypervisor 806 via response 866 (which causes hypervisor 806 to provide response 868 to virtual machine 808C comprising cryptographic result 864), provides an indication that the cryptographic operation is completed to hypervisor 806 via response 866 (which causes hypervisor 806 to provide the indication as response 868 to virtual machine 808C), and/or writes cryptographic result 864 to memory accessible to virtual machine 808C.

Several examples of partitioning an HSM and utilizing a partitioned HSM have been described with respect to FIGS. 8-10. In embodiments, requests received for virtual functions 814A-814C utilize communication bandwidth. Embodiments of HSM 112A implement different processes to distribute utilization of communication bandwidth across virtual functions 814A-814C. For instance, in an example, data transfer requests are fetched in a round-robin order. In another example, virtual functions 814A-814C are programmed to be strict or greedy. In strict mode, a virtual function is allotted a predetermined number of credits. A credit is consumed when a request is issued to the virtual function. A request cannot be issued to the virtual function if there are no credits remaining. In greedy mode, a virtual function is allowed to consume unused credits of other virtual functions. For instance, if virtual function 814A is in greedy mode and has no credits remaining and virtual function 814B (not in greedy mode) has a credit remaining, request 838 is issued by consuming virtual function 814B's credit. In an example, if multiple virtual functions are operating in greedy mode, they are allowed to consume a proportion amount of unused credits. For example, suppose interface 812A is in greedy mode and interfaces 812B and 812C are in strict mode. In this example, interface 812A is allowed to consume all unused credits. In another example, suppose interfaces 812A and 812B are in greedy mode with zero credits and interface 812C is in strict mode with four credits. In this example, interface 812A is allowed to consume two of interface 812C's unused credits and interface 812B is allowed to consume the other two of interface 812C's unused credits.

### IV. Example Key Migration Embodiments

In embodiments, an HSM may determine to migrate keys from itself to another distributed HSM (e.g., another HSM in the same server infrastructure). For instance, in an example embodiment, if the server or a device on the server is failing or if the server or a device is subject to a tamper event, the distributed HSM determines to migrate keys from one HSM to another. Depending on the implementation, the destination HSM is selected based on a pre-configuration of the HSMs or based on a server searching/finding another server to transfer the keys to.

In an example embodiment, keys are migrated from one server to another along with an instance of an associated virtual machine. Systems described herein are configurable in various manners to migrate keys in this way. For instance, FIG. 11 shows a block diagram of an example system 1100 for migrating keys from a distributed hardware security module to another hardware security module, in accordance with an example embodiment. As shown in FIG. 11, system 1100 comprises servers 106A and 106N, as described with respect to FIG. 1. As also shown in FIG. 11, server 106A comprises a host system 1102A (which is a further example of host processor 108A and host memory 110A) and HSM 112A (comprising crypto handler 120A and key cache 122A) and server 106N comprises a host system 1102N (which is a further example of host processor 108N and host memory 110N) and HSM 112N (key generator 1106N and decrypter 1110). Host system 1102A comprises virtual machine 118A and host processor 108A and host system 1102N comprises virtual machine 118N and host processor 108N. In accordance with an embodiment described herein with respect to FIG. 11, virtual machine 118N is an instance of virtual machine 118A.

Key generator 1106A and encrypter 1108 are sub-components of crypto handler 120A and key generator 1106N and decrypter 1110 are sub-components of crypto handler 120N. In embodiments, these sub-components are utilized to facilitate key migration between HSM 112A and HSM 112N. To better understand operation of system 1100, FIG. 11 is described with respect to FIG. 12. FIG. 12 shows a flowchart 1200 of a process for migrating keys from a distributed hardware security module to another hardware security module, in accordance with an example embodiment. In accordance with an embodiment, system 1100 operates according to flowchart 1200. Note that not all steps of flowchart 1200 need be performed in all embodiments. Further structural and operational embodiments will be apparent to persons skilled in the relevant art(s) based on the following descriptions of FIGS. 11 and 12.

Flowchart 1200 begins with step 1202. In step 1202, an attribute is received from the host processor. For example, key generator 1106A receives, from host processor 108A, a response 1114 comprising an attribute of virtual machine 118A, e.g., attribute 1104. In embodiments, host processor 108A receives attribute 1104 from virtual machine 118A in an attribute signal 1112. In embodiments, attribute signal 1112 is generated in response to host processor 108A requesting attribute information of virtual machine 118A and/or host system 1102A or HSM 112A determining virtual machine 118A is going to be migrated to another server. In accordance with an embodiment, attribute 1104 is specific to a particular interface of HSM 112A (e.g., based on (or representative of) a binding of virtual machine 118A to that particular interface of HSM 112A).

In step 1204, a migration key is generated based on the attribute. For example, key generator 1106A generates a migration key 1116 based on attribute 1114. In accordance with an embodiment, key generator 1106A generates migration key 1116 by utilizing attribute 1114 as input to a key generating algorithm. In a further implementation, key generator 1106A utilizes a distributed HSM value (e.g., a predetermined value, a nonce, or the like) that is shared across HSMs of a server infrastructure to generate migration key 1116. In this context, other distributed HSMs of the server infrastructure are able to recreate the migration key 1116 based on the distributed HSM value and attribute 1114. In accordance with an embodiment, migration key 1116 is a (e.g., single) key utilized for symmetrical encryption/decryption. Alternatively, migration key 1116 is a key pair comprising an encrypting migration key and a decrypting migration key.

In step 1206, the cryptographic key is encrypted with the migration key, resulting in a wrapped key. For example, encrypter 1108 encrypts key 208 with migration key 1116 (e.g., the encrypting migration key if migration key 1116 is a key pair), resulting in a wrapped key 1118.

In step 1208, the wrapped key is provided to the host processor. For example, as shown in FIG. 11, encrypter 1108 provides wrapped key 1118 to host processor 108A. In an embodiment, encrypter 1108 does not provide host processor 108A with migration key 1116, thereby preventing unauthorized access to an unwrapped version of wrapped key 1118. In an embodiment, host processor 108A packages wrapped key 1118 and virtual machine 118A in a file or other group of data for transmitting to another server. As shown in FIG. 11, host system 1102A transmits wrapped key 1118 and virtual machine 118A to host system 1102N via transmission signal 1124. In embodiments, host system 1102A selects host system 1102N as the destination host system based on bandwidth availability of host systems in a server infrastructure, hardware capabilities of the server, configuration of the user account associated with virtual machine 118A, a restriction of metadata of key 208, randomly, and/or based on any other information associated with the operation of servers of the server infrastructure and intended workloads of the virtual machine instance being transferred. In embodiments, host system 1102N deploys (e.g., executes) a new instance of virtual machine 118A as virtual machine 118N responsive to transmission signal 1124. In this context, virtual machine 118N shares the same attribute 1104 as virtual machine 118A.

In step 1210, the wrapped key and the attribute are received from the host processor. For example, key generator 1106N receives key data signal 1128 from host processor 108N. In accordance with an embodiment, key data signal 1128 comprises wrapped key 1118 and attribute 1104. In accordance with an embodiment, key generator 1106N receives key data signal 1128 prior to host system 1102N completing deployment of virtual machine 118N. In this context, HSM 112N is able to determine whether or not to authorize complete deployment of virtual machine 118N with reduced risk to server 106N (e.g., as opposed to waiting for virtual machine 118N to be fully deployed).

In step 1212, the migration key is generated based on the attribute. For example, key generator 1106N generates a migration key 1130 based on attribute 1104 included in key data signal 1128. In an embodiment, migration key 1130 is equivalent to the migration key utilized to generate wrapped key 1118. Alternatively, migration key 1130 is a key pair (or corresponds to a key pair) comprising an encrypting migration key (e.g., equivalent to the key used to generate wrapped key 1118) and a decrypting migration key (e.g., configured for use in decrypting results of encrypting with the encrypting migration key). In accordance with an embodiment, key generator 1106N generates migration key 1130 based on a (e.g., shared) distributed HSM value (e.g., in addition to attribute 1104). In accordance with an embodiment, key generator 1106N generates migration key 1130 in a similar manner to that described with respect to key generator 1106A and migration key 1116.

In step 1214, the migration key is utilized to unwrap the wrapped key. For example, decrypter 1110 utilizes migration key 1130 to attempt to unwrap wrapped key 1118. If decrypter 1110 is successful, migration of the instance of virtual machine 118A and key cache 122A to server 10N succeeded and flowchart 1200 proceeds to step 1216. If decrypter 1110 is unable to unwrap wrapped key crypto handler 120N, migration of keys of key cache 122A failed. In an example where migration of keys failed, HSM 112N communicates to central HSM 102 of FIG. 1 to obtain new keys.

In step 1216, the first cryptographic key is stored in memory accessible to a second hardware security module. For example, decrypter 1110 stores key 208 in key cache 122N via key storage 1132. Key 208 is stored in key cache 122N in a similar manner as described with respect to step 304 of FIG. 3, as well as elsewhere herein.

Several embodiments of migration between HSMs have been described with respect to FIGS. 11 and 12. In some embodiments, an HSM migrates keys (e.g., key 208) to another HSM utilizing an asymmetric process. For instance, in accordance with an embodiment, HSMs 112A and 112N comprise shared entropy (e.g., are manufactured with the shared entropy, are programmed with the shared entropy, have access to memory that stores the same entropy). In this context, HSM 112A and HSM 112N are configured to generate migration keys (e.g., migration key 1116, migration key 1130, and/or the like) based on the entropy. In a further example of such embodiments, migration keys are not exposed outside of the distributed HSM.

### VI. Example Expanded Storage Embodiments

Embodiments of an HSM are configured to utilize host memory to securely store keys in various ways, in embodiments. In some situations, the key cache of an HSM is limited in size. In this context, a distributed HSM operates in various ways to leverage host memory in a secure manner, in some embodiments. For example, FIG. 13 shows a block diagram of an example system 1300 for utilizing host memory to securely store keys, in accordance with an example embodiment. In an embodiment, system 1300 is a further example of server 106A of FIG. 1. System 1300 comprises HSM 112A and a host system 1302. As shown in FIG. 13, HSM 112A comprises key cache 122A (storing key 208 and a wrapping key 1310), a cache monitor 1304, and crypto handler 120A (as described elsewhere herein). Crypto handler 1308 comprises an encrypter 1306 and a decrypter 1308. As also shown in FIG. 13, host system 1302 comprises host processor 108A and host memory 110A, as described with respect to FIG. 1. To better understand the operation of system 1300, FIG. 13 is described with respect to FIGS. 14 and 15. FIG. 14 shows a flowchart 1400 of a process for utilizing host memory to securely store keys, in accordance with an example embodiment, and FIG. 15 shows a flowchart 1500 of a process for accessing keys securely stored in host memory, in accordance with an example embodiment. In accordance with an embodiment, HSM 112A of FIG. 13 operates according to flowcharts 1400 and 1500. Note that not all steps of flowchart 1400 and/or flowchart 1500 need be performed in all embodiments. Further structural and operational embodiments will be apparent to persons skilled in the relevant art(s) based on the following descriptions of FIGS. 13-15.

With respect to flowchart 1400, flowchart 1400 begins with step 1402. In step 1402, a storage criterion of the hardware security module is determined to be satisfied. For example, cache monitor 1304 determines a storage criterion of HSM 112A is satisfied. Depending on the implementation, the storage criterion is satisfied if key cache 122A is full, if a number of keys stored in key cache 122A is at and/or above a predetermined number, if a percentage of storage space is at and/or above a threshold. As shown in FIG. 13, cache monitor 1304 monitors key cache 122A via cache monitoring signal 1314. If the storage criterion is satisfied, cache monitor 1304 generates a storage alert 1316 indicating as such.

In step 1404, a public wrapping key is utilized to encrypt the first cryptographic key, resulting in a wrapped key. For example, encrypter 1306 utilizes an encryption key of wrapping key 1310 to encrypt cryptographic key 208 (and/or other keys stored in key cache 122A), resulting in one or more wrapped keys. In accordance with an embodiment, wrapping key 1310 is a key pair comprising the encryption key and a corresponding decryption key. Alternatively, wrapping key 1310 is a (e.g., single) key utilized in symmetrical cryptography. In accordance with an embodiment, encrypter 1306 determines which keys stored in key cache 122A are least used and/or least likely to be used within a predetermined time window (e.g., based on activity of crypto handler 120A and/or tenants of the cloud service). In this context, encrypter 1306 encrypts keys that are least used and/or least likely to be used (or a predetermined number of such keys) with the public wrapping key of wrapping key 1310.

In step 1406, the host processor is caused to store the wrapped key in a host memory. For example, encryptor 1306 transmits the one or more wrapped keys to host processor 108A via key storage request 1320. Key storage request 1320 causes host processor 108A to store the one or more wrapped keys in host memory 110A (e.g., as a wrapped key 1312) via storage signal 1322.

In order to utilize a key stored in host memory, HSM 112A operates according to flowchart 1500, in an embodiment. Flowchart 1500 begins with step 1502. In step 1502, a key request is transmitted to the host processor for the wrapped key. For example, crypto handler 120 transmits a key request 1324 to host processor 108A for wrapped key 1312. In an example, crypto handler 120A transmits key request 1324 responsive to host system 1302 (or a guest hosted by host system 1302) transmitting a request to perform a cryptographic operation utilizing the unwrapped version of wrapped key 1312 (i.e., key 208). Responsive to receiving key request 1324, host processor 108A accesses host memory 110A to obtain wrapped key 1312 via key retrieval signal 1326.

In step 1504, responsive to receiving the wrapped key, the wrapped key is decrypted, resulting in the first cryptographic key. For example, decrypter 1308, responsive to receiving key response 1328 comprising wrapped key 1312, utilizes a decryption key of wrapping key 1310 to decrypt wrapped key 1312, resulting in key 208. Depending on the implementation, the decryption key is a symmetrical wrapping key (i.e., the same used to decrypt key 208, In accordance with an embodiment, decrypter 1308 stores key 208 in key cache 122A via storage signal 1330.

In step 1506, the first cryptographic key is utilized to perform a cryptographic operation. For example, crypto handler 120A utilizes key 208 to perform a cryptographic operation, in a similar manner as described with respect to step 308 of flowchart 300 of FIG. 3, as well as elsewhere herein.

### VII. Example Attestation and Tamper Event Detection Embodiments

In embodiments, a distributed HSM operates to attest to the validity and configuration of a system (e.g., a server or other computing device the distributed HSM is implemented on, a host processor or memory of the server, a guest hosted by the host, an application executed by a guest, firmware of the guest, additional devices of the server/computing device (e.g., sensors, accelerators, etc.), and/or the like) and detect attempts to tamper with the system. For instance, FIG. 16 shows a block diagram of an example system 1600 for system attestation and tamper event detection, in accordance with an example embodiment. As shown in FIG. 16, system 1600 comprises server 106A (as described with respect to FIG. 1) and a mitigation service 1602. Mitigation service 1602 is a network-accessible service executed by a computing device external to server 106A. Depending on the implementation, mitigation service 1602 is executed by another device of the server structure comprising server 106A (e.g., server infrastructure 104 of FIG. 1), executed by a central computing device of a data center to which server 106A is part of (e.g., a central computing device that manages servers of a data center and HSMs implemented thereon), and/or a computing device external to the data center.

As shown in FIG. 16, server 106A comprises HSM 112A, as described with respect to FIG. 1, a host system 1604, a baseboard management controller 1606 (“BMC 11806” herein), an intrusion sensor 1608, a voltage sensor 1610, a temperature sensor 1612, and a frequency sensor 1614. BMC 1606 monitors the state of server 106A. For instance, BMC 1606 monitors physical variables (e.g., temperature, humidity, power supply voltage, fan speeds, communications parameters, and operating system functions), monitors firmware (e.g., BIOS, UEFI, etc.) of host system 1604, provides measurements of measured variables, provides information regarding monitored firmware, and/or performs other functions related to baseboard management.

Server 106A of FIG. 16 comprises a plurality of sensors configured to measure physical properties. For instance, intrusion sensor 1608 is configured to detect whether or not someone attempted to physically intrude (e.g., open, damage, take apart) a chassis/enclosure of server 106A. Voltage sensor 1610 is configured to measure a voltage applied to a hardware device of server 106A. Temperature sensor 1612 is configured to measure an ambient temperature with respect to server 106A and/or a temperature of a particular component of server 106A (e.g., a temperature of host processor 108A). Frequency sensor 1614 is configured to measure a clock speed of a processor (e.g., host processor 108A) and/or of a signal received by server 106A and/or generated by a component of server 106A. In embodiments, the sensors report their measurement to BMC 1606 and/or HSM 112A.

As shown in FIG. 16, host system 1604 comprises host processor 108A and virtual machine 118A (comprising OS 202 and application 204, as described with respect to FIG. 2), as described with respect to FIG. 1. As also shown in FIG. 16, HSM 112A comprises an attestor 1616, a tamper event detector 1618, an auxiliary power source 1640, and a real-time clock (RTC) 1642. Examples of auxiliary power source 1640 include, but are not limited to, batteries, supercapacitors, and/or the like. In an embodiment, auxiliary power source 1640 is utilized to power RTC 1642, even if power is removed from server 106A. In this context, RTC 1642 keeps track of time when server 106A is off. Examples of RTC 1642 include, but are not limited to, crystal oscillators and micromechanical resonators.

Attestor 1616 and tamper event detector 1618 are implemented as sub-components and/or services of HSM 112A. Attestor 1616 is configured to attest to the validity of and/or the configuration of hardware, firmware, and software of system 1600. For example, FIG. 17 shows a flowchart 1700 of a process for attesting the validity of a system, in accordance with an example embodiment. In accordance with an embodiment, attestor 1616 operates according to flowchart 1700. Note that not all steps of flowchart 1700 need be performed in all embodiments. Further structural and operational embodiments will be apparent to persons skilled in the relevant art(s) based on the following descriptions of FIGS. 16 and 17.

Flowchart 1700 begins with step 1702. In step 1702, an attribute representative of a system feature of a system is received. For example, attestor 1616 receives an attribute 1620C from BMC 1606 via attribute signal 1622, attribute 1620A and/or an attribute 1620B from host system 1604 via attribute signal 1624, and/or an attribute 1620D. Attributes 1620A-1620D are representative of a system feature of system 1600 (i.e., the system HSM 112A is implemented in). For instance, attribute 1620A is an attribute of virtual machine 118A (e.g., an identifier of virtual machine 118A, a time in which virtual machine 118A was established, a type of virtual machine 118A, an account virtual machine 118 is associated with, an identifier of an application executed by virtual machine 118A (e.g., application 204), and/or another feature of virtual machine 118A), attribute 1620B is an attribute of host system 1604 (e.g., an identifier of host system 1604, a type of processor of host processor 108A, a clock speed of host processor 108A, an OS of host system 1604, a firmware of host system 1604, tenants associated with host system 1604, and/or another feature of host system 1604 (or a component thereof)), attribute 1620C is an attribute of BMC 1606 (e.g., a type of BMC 1606, firmware of host system 1604, devices of server 106A (e.g., SoCs, accelerators, sensors, etc.), measurements determined by BMC 1606, and/or another feature of BMC 1606), and attribute 1620D is an attribute of HSM 112A (e.g., an endorsement key (also referred to as an attestation key) of attestor 1616, an identifier of HSM 112A, a partition of HSM 112A, and/or another feature of HSM 112A). In embodiments, attestor 1616 may receive other attributes as well, such as, but not limited to, an output of a sensor of system 1600, a register of tamper event detector 1618, etc.

In step 1704, a determination of whether or not the attribute satisfies an attestation criterion is made. For example, attestor 1616 of FIG. 16 determines whether or not attribute 1620A, 1620B, 1620C, and/or 1620D satisfy an attestation criterion. In accordance with an embodiment, attestor 1616 determines if the attestation criterion is satisfied based on whether or not received attribute information matches stored attribute information. In accordance with an embodiment, the attestor 1616 binds operations to initial (or expected) attribute information. In this context, if the attributes received in step 1702 do not match the initial/expected attribute information, attestor 1616 does not attest to system 1600. In embodiments, if the attestation criterion is satisfied, flow continues to step 1706. Otherwise, flow continues to step 1708.

In accordance with an embodiment, attestor 1616 (or another component of HSM 112A) maintains an inventory of permitted platform firmware measurements (e.g., firmware of HSM 112A, firmware of host 1604, firmware of another component of server 106A, and/or the like). If attestor 1616 determines a component attests to a firmware version other than the firmware maintained in the inventory, an attestation policy violation is flagged and attestor invalidates the component's firmware measurement. In this context, attestor 1616 transmits an invalidity signal 1626 to tamper event detector 1618.

In a further embodiment, attestor 1616 comprises key generation logic. In this context, attestor 1616 generates an attestation key (e.g., a device manufacturing endorsement (DME) key). The attestation key is an asymmetric key pair (comprising a public DME key and a private DME key) utilized for attestation. In an implementation, the attestation key pair uniquely identifies HSM 112A. In embodiments, access to the private DME key is restricted to (e.g., only) HSM 112A. HSM 112A utilizes the private attestation key to endorse attestation of the system (e.g., measurements made) and other components and/or services utilize the public attestation key to verify the endorsement.

In accordance with an embodiment, the attestation key is generated utilizing a random number generator (e.g., a digital random bit generator (e.g., utilizing a one-time programmable (OTP) memory)). In accordance with an embodiment, the attestation key is generated utilizing an attestation seed. In some implementations, the attestation seed is obfuscated by gates, unique static entropy, and/or a physically unclonable function. In this manner, exposure of the attestation seed is mitigated. In accordance with an embodiment where the attestation seed is stored in OTP memory, cryptographic blinding and/or silicon obfuscation upon key derivation and/or hardware key cache import are implemented (in some embodiments) to further reduce exposure risk of the attestation key. In accordance with a further embodiment, the OTP memory is hardware protected in a manner to restrict guest/host firmware access. In accordance with an embodiment, an attestation key is not impacted by zeroization of HSM 112A (e.g., the attestation key persists even if HSM 112A (and/or its key cache and/or firmware) is wiped). In accordance with an alternative embodiment where HSM 112A is partitioned into multiple partitions (e.g., as described with respect to FIG. 8), each partition generates a unique attestation key that is accessible to that partition (i.e., such that the private key of the attestation key pair is not accessible to other partitions of HSM 112A).

In accordance with an embodiment, use of keys are bound to a particular session. In this context, attestor 1616 (or another component of HSM 112A) binds keys of HSM 112A's key cache to an instance of virtual machine 118A and/or application 204. If virtual machine 118A or the application are rebooted and the session with HSM 112A is restarted, the keys are no longer authorized for use with the new session. This prevents use of keys by an attacker targeting input/output bounce buffers.

In step 1706, performance of the cryptographic operations on behalf of a virtual machine of the system is allowed. For example, responsive to attestation of system 1600, HSM 112A provides secure key utilization for host system 1604 (and/or guests executing thereon) as described elsewhere herein.

In step 1708, attesting the validity of the system fails. For example, attestor 1616 indicates a failure to attest system 1600. As shown in FIG. 16, in some embodiments, attestor 1616 transmits an invalidity signal 1626 to tamper event detector 1618 indicating system 1600 is invalid. In this context, tamper event detector 1618 is able to detect potential tampering with system 1600 (e.g., in an attempt to have unauthorized access secrets protected by HSM 112A).

Thus, an example process for attesting a system has been described with respect to flowchart 1700 of FIG. 17. In accordance with an embodiment, attestor 1616 attests hardware of server 106A utilizing an out-of-band communication link (e.g., an I2C or improved inter-integrated circuit (13C) communication link). This out-of-band communication link enables attestor 1616 to attest validity of hardware without interfering with other communication links or risking tampering of data over the out-of-band communication link. Furthermore, in a further embodiment, once a hardware component of server 106A is attested, HSM 112A utilizes the out-of-band communication link as a secure path to export/import keys to the hardware (e.g., exporting keys to secure accelerator 234 of FIG. 2, migrating keys to another HSM of server 106A, migrating keys to an HSM of another server).

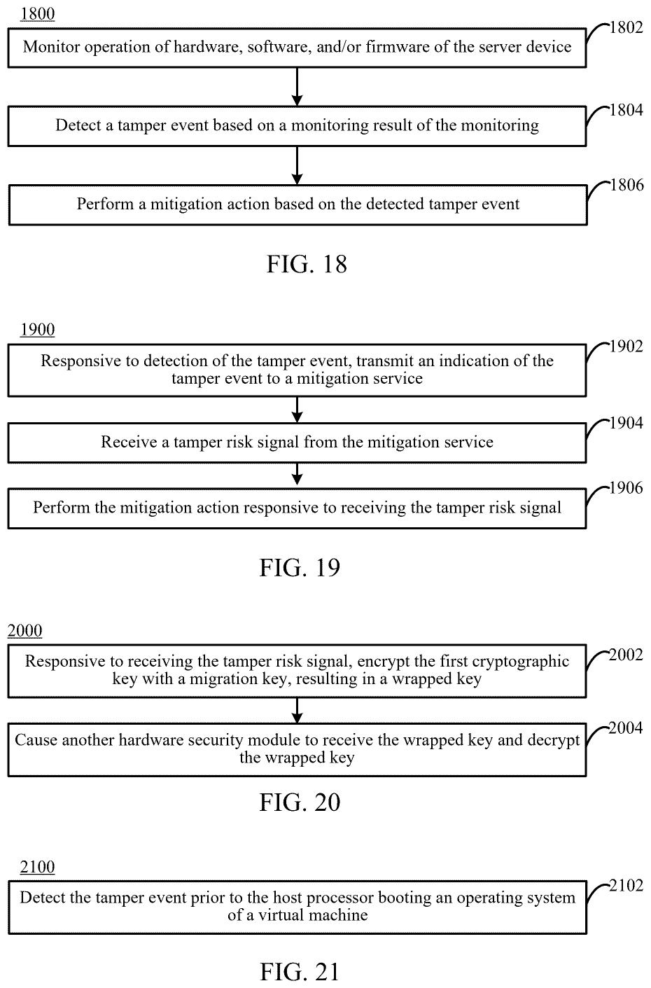

Tamper event detector 1618 of FIG. 16 is configured to detect potential tamper events and perform mitigating actions based on the detected tamper event in various ways, in embodiments. For example, FIG. 18 shows a flowchart 1800 of a process for mitigating a tamper event, in accordance with an example embodiment. In accordance with an embodiment, tamper event detector 1618 operates according to flowchart 1800. Note that not all steps of flowchart 1800 need be performed in all embodiments. Further structural and operational embodiments will be apparent to persons skilled in the relevant art(s) based on the following description of FIG. 18 with respect to FIG. 16.

Flowchart 1800 begins with step 1802. In step 1802, hardware, software, and/or firmware of the server device is monitored. For example, tamper event detector 1618 monitors output of intrusion sensor 1608, voltage sensor 1610, temperature sensor 1618, and frequency sensor 1614, monitors host system 1604 via host monitoring signal 1622, monitors BMC 1606 via BMC monitoring signal 1622 and monitors components of HSM 112A (e.g., RTC 1642, attestor 1616, crypto handler(s), key cache(s), etc. Depending on the implementation, tamper event detector 1618 polls a component to cause the component to provide the corresponding monitoring signal, or tamper event detector 1618 receives monitoring signals from components (e.g., the component pushes the signal to tamper event detector 1618).

In step 1804, a tamper event is detected based on a monitoring result of the monitoring. For example, suppose tamper event detector 1618 of FIG. 16 detects a (e.g., potential) tamper event based on a result of the monitoring in step 1802. In this context, tamper event detector 1618 detects a tamper event in various ways. For instance, tamper event detector 1618 in an example detects a potential tamper event utilizing code-flow integrity protection to detect errors in code executed by host system 1604 or HSM 112A. In another example, tamper event detector 1618 receives an intrusion signal 1628 from intrusion sensor 1608 responsive to a malicious entity physically opening an enclosure of server 106A. Intrusion signal 1628 indicates the enclosure of server 106A is compromised.

In accordance with an embodiment, tamper event detector 1618 monitors power events of server 106A and logs power events that occur. Examples of power events include, but are not limited to, loss of power to server 106A, server 106A powering on, server 106A entering or exiting a low-power state, a brownout or other type of interruption in power to server 106A, an increase in power delivered to server 106A, and/or the like. In some embodiments, tamper event detector 1618 detects a potential tamper event based on the power event. In another embodiment, tamper event detector 1618 causes attestor 1616 to re-attest validity of the system in response to the potential tamper event. In this context, tamper event detector 1618 detects potential attacks on the system that include manipulating/causing power events.

In some embodiments, tamper event detector 1618 monitors power consumed by server 106A during certain operations (e.g., power consumed during boot of a host operating system, power consumed during boot of host firmware, etc.). In this context, tamper event detector 1618 logs the power consumed during the operation. If power consumed during a subsequent occurrence of the operation varies by more than a predetermined threshold, tamper event detector 1618 flags a potential tamper event.

In step 1806, a mitigation action is performed based on the detected tamper event. For example, tamper event detector 1618 of FIG. 16 performs a mitigation action based on the tamper event detected in step 1804. Example mitigation actions include, but are not limited to, erasing key stored in a key cache of HSM 112A, causing a queue to be emptied, zeroizing HSM 112A, causing host processor 108A to cease hosting a guest (e.g., a guest with sensitive data, a guest that is flagged as potentially malicious, and/or the like), notifying an admin of the cloud service, notifying a user associated with an account associated with virtual machine 118A causing keys in a key cache to be migrated to a different HSM, and/or any other action or cause of an action suitable for mitigating potential/attempting compromise of HSM 112A. In some embodiments, tamper event detector 1618 causes multiple mitigation actions to be performed.

In accordance with an embodiment, tamper event detector 1618 comprises one or more registers (not shown in FIG. 16 for brevity). In this context, the register stores bits indicating whether or not a sensor (e.g., intrusion sensor 1608, voltage sensor 1610, temperature sensor 1612, frequency sensor 1614, etc.) detected a condition that satisfies a tamper event criterion. For instance, if intrusion sensor 1608 detects an intrusion to server 106A, a bit stored in a corresponding register of tamper event detector 1618 is changed (e.g., from 0 to 1, from 0 to 1, from one multi-bit value to another multi-bit value, etc.) to indicate the tamper event criterion was satisfied. Tamper event detector 1618 maintains similar registers for other sensors, such as, but not limited to, voltage sensor 1610, temperature sensor 1612, and frequency sensor 1614. In accordance with an embodiment, tamper event detector 1618 maintains a register for flagging other errors as well. For instance, a register in accordance with an embodiment stores a bit value (or a multi-bit value) indicative of BMC 1606 flagging an error, of attestor 1616 determining hardware (e.g., host hardware, BMC 1606, other hardware of server 106A), software, (e.g., virtual machine 118A, an application executed thereby, a host operating system of host 1604 (not shown in FIG. 16), and/or the like) and/or firmware is invalid for utilizing keys stored by HSM 112A, of a connection with RTC 1642 being interrupted or loss (e.g., due to loss of power in auxiliary power source 1640, tampering with RTC 1642, failure of RTC 1642, etc.), and/or the like.

In some embodiments, tamper event detector 1618 utilizes a mitigation service (e.g., mitigation service 1602) to confirm the detected potential tamper event poses a risk (e.g., to the system, to a user account, to the cloud service, etc.). Tamper event detector 1618 operates to utilize the mitigation service in various ways. For instance, FIG. 19 shows a flowchart 1900 of a process for mitigating a tamper event utilizing a mitigation service, in accordance with an example embodiment. In accordance with an embodiment, tamper event detector 1618 operates according to flowchart 1900. Note that not all steps of flowchart 1900 need be performed in all embodiments. Further structural and operational embodiments will be apparent to persons skilled in the relevant art(s) based on the following description of FIG. 19 with respect to FIG. 16.

Flowchart 1900 begins with step 1902. In step 1902, responsive to detection of the tamper event, an indication of the tamper event is transmitted to a mitigation service. For example, tamper event detector 1618 of FIG. 16, responsive to detection of the tamper event in step 1804, transmits an indication 1636 to mitigation service 1602. In embodiments, indication 1636 indicates the detected tamper event and comprises an identifier of HSM 112A, a timestamp of when the tamper event was detected, a type of tamper event detected, a user account associated the virtual machine or partition, and/or any other information related to the detection of a tamper event.

Indication 1636 causes mitigation service 1602 to analyze the tamper event and determine whether or not the potential tamper event satisfies a risk criterion. In an embodiment, mitigation service 1602 determines if the risk criterion is satisfied based on indication 1636 and previous indications of tamper events. For instance, if the indicated potential tamper event matches a pattern of known attacks (or a similarity of the pattern is within a certain percentage of the pattern of the known attack(s)), mitigation service 1602 determines the indication 1636 satisfies a risk criterion. In another example, mitigation service 1602 determines the risk criterion is satisfied based on a number of indications received from tamper event detector 1618 within a predetermined time. If risk criterion is satisfied, flowchart 1900 continues to step 1904.

In step 1904, a tamper risk signal is received from the mitigation service. For example, tamper event detector 1618 receives a tamper risk signal 1638 from mitigation service 1602. Tamper risk signal 1638 indicates the potential tamper event satisfies a risk criterion. In this context, mitigation service 1602 determined the detected potential tamper event satisfies a risk criterion. In a further embodiment, tamper risk signal 1638 comprises instructions for performing a mitigation action. For instance, tamper risk signal 1638 in accordance with an embodiment comprises instructions to migrate keys from HSM 112A to another HSM, clear the key cache, and/or perform another type of mitigating action, as described elsewhere herein.

Flowchart 1900 continues to step 1906, which is a further example of step 1806 of flowchart 1800. In step 1906, the mitigation action is performed responsive to receiving the tamper risk signal. For example, tamper event detector 1618 performs a mitigation action responsive to receiving tamper risk signal 1638. In accordance with an embodiment, tamper event detector 1618 determines the mitigation action to be performed and causes its performance. Alternatively, tamper risk signal 1638 comprises instructions to cause tamper event detector 1618 to perform a particular mitigation action.

In embodiments, tamper event detector 1618 operates to perform mitigation actions in various ways. For instance, tamper event detector 1618, in some embodiments, causes keys stored in a key cache to be migrated to another HSM. Mitigation actions comprising key migration are performed in various ways, in embodiments. For example, FIG. 20 shows a flowchart 2000 of a process for migrating a key to mitigate a tamper event, in accordance with an example embodiment. In accordance with an embodiment, tamper event detector 1618 of FIG. 16 and/or HSM 112A of FIG. 11 operates according to flowchart 2000. Note that not all steps of flowchart 2000 need be performed in all embodiments. Further structural and operational embodiments will be apparent to persons skilled in the relevant art(s) based on the following description of FIG. 20 with respect to FIGS. 11 and 16.

Flowchart 2000 begins with step 2002. In step 2002, responsive to receiving the tamper risk signal, the first cryptographic key is encrypted with a migration key, resulting in a wrapped key. For example, responsive to tamper event detector 1618 of FIG. 16 receiving tamper risk signal 1638, tamper event detector 1618 causes encrypter 1108 of FIG. 11 to encrypt key 208 with a migration key, resulting in wrapped key 1118.

In step 2004, the wrapped key is caused to be transferred to another hardware security module. For example, as shown in FIG. 11, encrypter 1108 causes wrapped key 1118 to be transferred to HSM 112N (e.g., via transmitting wrapped key 1118 to host system 1102A, which transmits it to host system 1102N, which provides the wrapped key to HSM 112N). While the example described migration process migrates keys using split-key migration (as described with respect to FIGS. 11 and 12), embodiments described herein are not so limited. For instance, in accordance with an embodiment, tamper event detector 1618 causes keys to migrate using a key shared between HSMs 112A and 112N.

In some embodiments, HSM 112A is able to detect tamper events before a guest is booted on a host system, or even before the host boot process has completed. HSMs operate to perform early tamper event detection in various ways. For example, FIG. 21 shows a flowchart 2100 of a process for early tamper event detection, in accordance with an example embodiment. In accordance with an embodiment, tamper event detector 1618 operates according to flowchart 2100. Note that flowchart 2100 need not be performed in all embodiments. Further structural and operational embodiments will be apparent to persons skilled in the relevant art(s) based on the following description of FIG. 21 with respect to FIG. 16.

Flowchart 2100 comprises step 2102. In step 2102, the tamper event is detected prior to the host processor booting an operating system of a virtual machine. For example, tamper event detector 1618 detects a tamper event prior to host processor 108A booting OS 202. In an embodiment, responsive to server 106A powering on (or otherwise beginning the process of booting an operating system of host 1604), attestor 1616 obtains attribute 1620C from BMC 1606 (e.g., via BMC signal 1622). Attestor 1616 determines whether or not server 106A is a valid system based on attribute 1620C. For instance, as an example, keys stored by HSM 112A (e.g., key 208 of FIG. 2) are signed with a signature that binds them to a particular hardware system. Suppose the signature was signed by a key that was bound to a particular BMC. In this context, HSM 112A is configured to utilize the signed keys if BMC 1606 is the particular BMC the signed keys are bound to. In an embodiment, if BMC 1606 is invalid, attestor 1616 transmits invalidity signal 1626 to tamper event detector 1618. Responsive to receiving invalidity signal 1626, tamper event detector 1618 causes a mitigation action to be performed based on BMC 1606 being invalid. In this manner, HSM 112A determines whether or not to attest to the validity of the system prior to the host completing a boot process, thereby allowing the host to utilize HSM 112A to perform secure operations during the boot process (e.g., if the system is attested).

In accordance with a further embodiment, HSM 112 comprises a stored version of the signature key and compares the generated signature key to the stored version to determine validity of BMC 1606. In accordance with an embodiment, HSM 112A prevents unauthenticated mutable code from executing prior to verification of BMC 1606. In accordance with an embodiment, HSM 112A prevents a hardware interface of server 106A (not shown in FIG. 16) from transmitting or receiving signals prior to verification of BMC 1606.

In some embodiments, a key is bound to a system by signing the key with a signature key that was generated based on its attributes. For instance, suppose a key was bound to BMC 1606 by signing the key with a signature key generated based on attribute 1620C. In this context, attestor 1616 generates a signature key based on attribute 1620C and attempts to verify a signature of the stored keys (not shown in FIG. 16 for brevity). If the signature key is able to verify the signature, BMC 1606 is valid. If the signature key is unable to verify the signature, BMC 1606 is invalid.

Flowchart 2100 of FIG. 21 has been described with respect to detecting a tamper event after server 106A is powered but prior to host processor 108A booting OS 202. In some embodiments, tamper event detector 1618 is able to detect tamper events even if server 106A is unpowered. For instance, as shown in FIG. 16, HSM 112A comprises auxiliary power source 1640 and RTC 1642. In this context, RTC 1642 powers one or more registers of tamper event detector 1618 while server 106A is unpowered. For instance, as a non-limiting example, suppose RTC 1642 powers the register of tamper event detector 1618 that indicates whether or not intrusion sensor 1608 detected an attempted (or successful) intrusion of server 106A's enclosure. In this context, tamper event detector 1618 is able to flag if a tamper event occurs (e.g., by grounding the register (e.g., if a voltage on the register indicates no intrusion), asserting the register high (i.e., if low indicates no intrusion), asserting the register low (i.e., if high indicates no intrusion), and/or the like). In some embodiments, other tamper events are (e.g., also or alternatively) detectable in unpowered scenarios (e.g., detecting a temperature-based tamper event via temperature sensor 1612).

### VIII. Example HSM Firmware Verification Embodiments

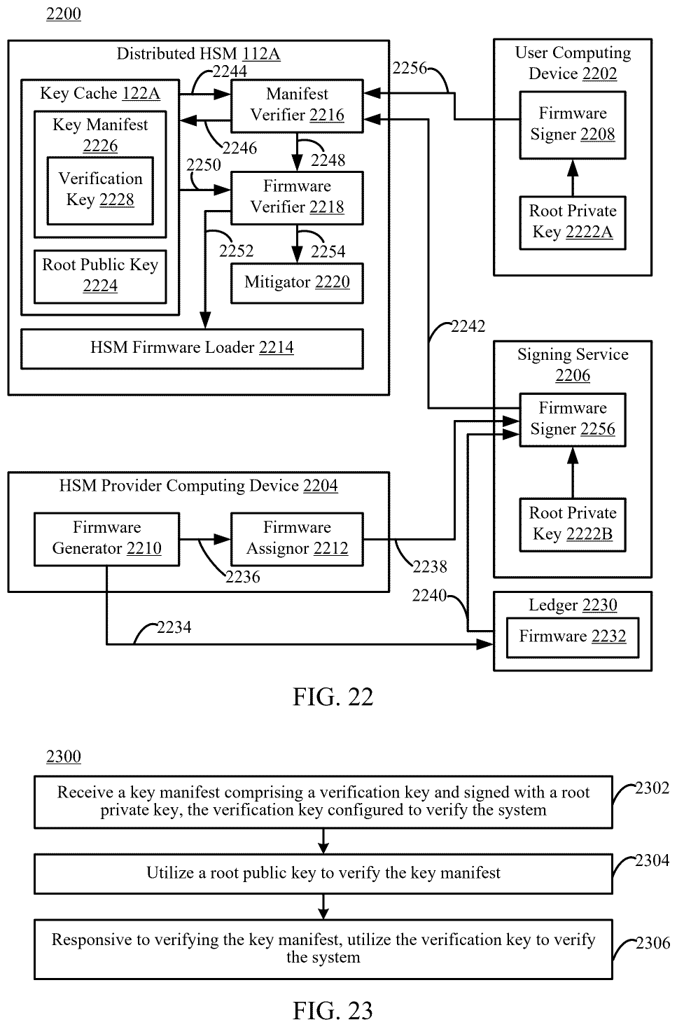

As a platform root of trust, embodiments of a distributed HSM is responsible for code integrity policy for hardware and firmware. In an example, the distributed HSM provides a delegated policy enforcement mechanism over update, rollback, and deployment of firmware components of a host server. However, in some scenarios, a user utilizing a server treats the provider of firmware for the HSM (e.g., a cloud service provider) (also referred to as the “HSM provider” herein) as an untrusted entity. In some embodiments, the HSM orchestrates verification of firmware (or other parts of the HSM) in a manner that is tamper proof or tamper evident. Embodiments described herein operate in various ways to verify firmware in a tamper proof/evident manner. For example, FIG. 22 shows an example system 2200 for verifying firmware of a distributed firmware, in accordance with an example embodiment. System 2200 comprises distributed HSM 112A, as described with respect to FIG. 1, as well as a user computing device 2202, an HSM provider computing device 2204, a signing service 2206, and a ledger 2230, each of which are communicatively coupled via a network, not shown in FIG. 22 for brevity. System 2200 is described as follows.

User computing device 2202 is any stationary or mobile device associated with a user (e.g., a single user, a group of users, a customer of a cloud service, a tenant of a cloud service, a family user utilizing a cloud service, etc.). In embodiments, user computing device 2202 executes programming instructions to perform operations. For instance, user computing device 2202 executes a firmware signer 2208 to sign firmware utilizing a root private key 2222A. In this context, the firmware signer 2208 endorses firmware versions utilizing root private key 2222A.

HSM provider computing device 2204 is any stationary or mobile device associated with an HSM provider (e.g., a manufacturer of HSM 112A, a distributer of HSM 112A, a managing organization or user of HSM 112A, and/or the like). In embodiments, HSM provider computing device 2204 executes programming instructions to perform operations. For instance, HSM provider computing device 2204 executes firmware generator 2210 to generate firmware of an HSM (e.g., HSM 112A) and executes a firmware assignor 2212 to cause signing service 2206 to sign firmware. In accordance with an embodiment, HSM provider computing device 2204 manages ledger 2230 and data stored therein.

Ledger 2230 provides a tamper-evident data table, where data of ledger 2230 can be cryptographically attested to other parties, such as signing service 2206, user computing device 2202, and HSM 112A. Ledger 2230 protects data from attackers or high privileged users. In an embodiment, historical data is preserved in ledger 2230. For instance, in an implementation, if data is updated in ledger 2230, its previous value is maintained and protected in a history table. In this context, ledger 2230 provides a chronical of (e.g., all) changes made to it over time. As shown in FIG. 22, ledger 2230 maintains data indicative of firmware to be used for HSM 112A (e.g., firmware 2232).

Signing service 2206 is a service executing on a computing device (e.g., a server or another type) and is configured to utilize root private key 2222B to endorse firmware that HSM provider computing device 2204 intends to deploy to HSM 112A. In some embodiments, signing service 2206 is an independent service from the HSM provider. As shown in FIG. 22, signing service 2206 comprises a firmware signer 2256, which is configured to sign firmware generated by HSM provider computing device 2204 and deploy the signed firmware to HSM 112A.

As shown in FIG. 22, HSM 112A comprises key cache 122A, as described with respect to FIG. 1, as well as a manifest verifier 2216, a firmware verifier 2218, a mitigator 2220, and an HSM firmware loader 2214. Key cache 122A stores a key manifest 2226 and a root public key 2224. Key manifest 2226 is a tamper-proof/evident manifest signed with a private key and verifiable with a public key. As shown in FIG. 22, key manifest 2226 comprises verification key 2228. Verification key 2228 is a key configured to verify firmware. Root public key 2224 is a public key corresponding to either root private key 2222A or root private key 2222B. In this context, root public key 2224 is utilized to verify the signatures of firmware deployed to HSM 112A.

To better understand the operation HSM 112A with respect to HSM provider computing device 2204 and signing service 2206, FIG. 22 is described with respect to FIG. 23. FIG. 23 shows a flowchart 2300 of a process for verifying a system on behalf of a trusted third-party, in accordance with an example embodiment. In accordance with an embodiment, HSM 112A operates according to flowchart 2300. Note that not all steps of flowchart 2300 need be performed in all embodiments. Further structural and operational embodiments will be apparent to persons skilled in the relevant art(s) based on the following descriptions of FIGS. 22 and 23.

Prior to flowchart 2300 beginning, an updated version of HSM firmware is generated. For instance, suppose HSM provider computing device 2204 utilizes firmware generator 2210 to generate firmware 2232. Firmware generator 2210 writes the version of firmware 2232 to ledger 2232 via storage signal 2234 and provides firmware 2232 to firmware assignor 2212 via updated firmware signal 2236. By storing the version of firmware 2232 to ledger 2232, an entity is able to view the code of firmware 2232 to ensure it satisfies policies. Firmware assignor 2212 provides a signing request 2238 to firmware signer 2256, comprising a request to generate a key manifest to attest validity of the firmware update.

Firmware signer 2256 receives signing request 2238 and accesses ledger 2230 via ledger signal 2240 to verify if the firmware indicated in signing request 2238 is a valid version of HSM firmware. In embodiments, firmware signer 2256 compares code of the indicated firmware and the ledger firmware to determine if the firmware is valid. If the version is valid, firmware signer 2256 generates key manifest 2226 comprising verification key 2228. Firmware signer 2256 signs key manifest 2226 with root private key 223 and transmits the signed version of key manifest 2226 to HSM 112A and flow begins with flowchart 2300.

Flowchart 2300 begins with step 2302. In step 2302, a key manifest is received, the key manifest comprising a verification key and signed with a root private key, the verification key configured to verify the system. For example, manifest verifier 2216 receives key manifest 2226 via signed signal 2242 from firmware signer 2256. In an embodiment, signed signal 2242 also comprises the updated version of the firmware. Alternatively, the updated version is transmitted to HSM 112A as a separate signal. In another alternative, signed signal 2242 (or a separate signal) comprises a pointer to a buffer where the update is stored.

In step 2304, a root public key is utilized to verify the key manifest. For example, manifest verifier 2216 obtains root public key 2224 via signal 2244 and utilizes root public key 2224 to attempt to verify key manifest 2226. If key manifest 2226 is verified, manifest verifier 2216 stores key manifest 2226 in key cache 122A via storage signal 2250.

In step 2306, responsive to verifying the key manifest, the verification key is utilized to verify the system. For example, firmware verifier 2218 receives an indication 2248 from manifest verifier 2216 indicating key manifest 2226 is verified. Responsive to indication 422, firmware verifier 2218 obtains verification key 2228 and utilizes verification key 2228 to verify a signature of the firmware. If firmware verifier 2218 successfully verifies the firmware, it causes HSM firmware loader 2214 to load the new firmware (and discard the current firmware). If firmware verifier 2218 fails to verify the firmware, it causes mitigator 2220 to perform a firmware mitigation action. Example firmware mitigation actions include, but are not limited to, discarding the updated firmware, transmitting a request for a new update to the HSM provider computing device 2204, transmitting an error message to signing service 2206 indicating there was an mismatch in the firmware signature and the verification key, transmitting an error message to the user (e.g., to user computing device 2202) indicating there was an attempt to install unauthorized firmware.

Thus, an example process for verifying firmware has been described with respect to FIGS. 22 and 23. In some embodiments, and as shown in FIG. 22, user computing device 2202 provides key manifest 2226 to HSM 112A. In this context, HSM 112A operates in a similar manner as described with respect to flowchart 2300 of FIG. 23 with the following differences. Suppose user has a firmware update or update enforcement requirements. In this context, user computing device signs a firmware update (e.g., a firmware image) utilizing root private key 2222A. In this context, the user computing device endorses the firmware update. HSM 112A verifies the manifest utilizing root public key 2224 (which, in this example, is a public key corresponding to root private key 2222A). In this context, the HSM provider is unable to update firmware of HSM 112A without the user endorsing the firmware update. In this context, the user has control over software/firmware updates to HSM 112A and HSM 112A implements cryptographic measurements trusted by the user and that are unforgeable (e.g., by the HSM provider or another party).

This operation of HSM 112A has been described with respect to verifying firmware of a user; however, embodiments of the present disclosure are not so limited. For instance, in a further embodiment, HSM 112A attests to whether or not software and/or hardware of a server is operating within security policies of the user. In this context, an attestor of HSM 112A (e.g., attestor 1616) attests software executed by a guest, firmware of a guest, hardware of a server, and/or the like is compliant with the user's security policies.

In some embodiments, the HSM provider is able to “zeroize” HSM 112A (e.g., erase the user's secrets without the secrets being exposed to the HSM provider). By allowing the HSM provider to zeroize HSM 112A, the HSM provider is able to re-provision HSM 112A (and its server) to another user (e.g., if the first user no longer needs the server HSM 112A is operating on, if the user is no longer a customer of the HSM provider, if the user's lease of HSM 112A expires, etc.).

### IX. Example Computer System Implementation

Embodiments of dynamic job routing and data consolidation described herein are implemented in hardware, or hardware combined with one or both of software and/or firmware. For example, virtual machine 118A, virtual machine 118N, crypto handler 120A, crypto handler 120N, key cache 122A, key cache 122N, crypto handler 124, key vault 126, OS 202, application 204, enclave 206, enclave 804, hypervisor 806, virtual machines 808A-808C, interfaces 812A-812C, virtual functions 814A-814C, partition manager 818, key generator 1106A, key generator 1106N, encrypter 1108, decrypter 1110, cache monitor 1304, encrypter 1306, decrypter 1308, mitigation service 1402, attestor 1416, tamper event detector 1418, signing service 2206, firmware signer 2208, firmware generator 2210, firmware assignor 2212, HSM firmware loader 2214, manifest verifier 2216, firmware verifier 2218, mitigator 2220, ledger 2230, firmware 2232, firmware signer 2256, and/or the components described therein, and/or the steps of flowcharts 300, 400, 500, 700, 900, 1000, 1200, 1400, 1500, 1700, 1600, 1700, 1800, 1900, and/or 2200, are each implemented as computer program code/instructions configured to be executed in one or more processors and stored in a computer readable storage medium. Alternatively, central HSM 102, server 106A, server 106N, host processor 108A, host processor 108N, host memory 110A, host memory 110N, HSM 112A, HSM 112N, security coprocessor 114A, security coprocessor 114N, HSM memory 116A, HSM memory 116N, virtual machine 118A, virtual machine 118N, crypto handler 120A, crypto handler 120N, key cache 122A, key cache 122N, crypto handler 124, key vault 126, OS 202, application 204, enclave 206, sensor 232, secure accelerator 234, accelerator 236, host system 802, enclave 804, hypervisor 806, virtual machines 808A-808C, interfaces 812A-812C, virtual functions 814A-814C, partition manager 818, host system 1102A, host system 1102N, key generator 1106A, key generator 1106N, encrypter 1108, decrypter 1110, cache monitor 1304, encrypter 1306, decrypter 1308, mitigation service 1602, host system 1604, BMC 1606, intrusion sensor 1608, voltage sensor 1610, temperature sensor 1612, frequency sensor 1614, attestor 1616, tamper event detector 1618, auxiliary power source 1640, RTC 1642, signing service 2206, firmware signer 2208, firmware generator 2210, firmware assignor 2212, HSM firmware loader 2214, manifest verifier 2216, firmware verifier 2218, mitigator 2220, ledger 2230, firmware 2232, firmware signer 2256, and/or the components described therein, and/or the steps of flowcharts 300, 400, 500, 700, 900, 1000, 1200, 1400, 1500, 1700, 1700, 1800, 1900, 2000, 2100, and/or 2300 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

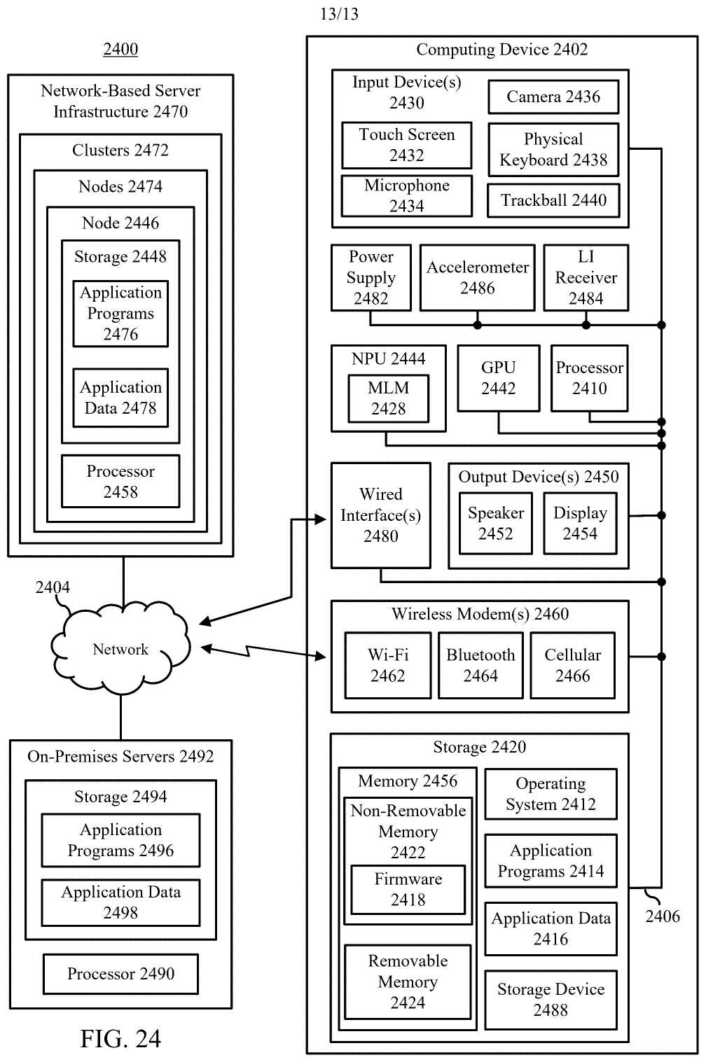

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 24. FIG. 24 shows a block diagram of an exemplary computing environment 2400 that includes a computing device 2402. Computing device 2402 is an example of server 106A, server 106N, user computing device 2202, and/or HSM provider computing device 2204, which each include one or more of the components of computing device 2402. In some embodiments, computing device 2402 is communicatively coupled with devices (not shown in FIG. 24) external to computing environment 2400 via network 2404. Network 2404 is an example of network 144 of FIG. 1. Network 2404 comprises one or more networks such as local area networks (LANs), wide area networks (WANs), enterprise networks, the Internet, etc. In examples, network 2404 includes one or more wired and/or wireless portions. In some examples, network 2404 additionally or alternatively includes a cellular network for cellular communications. Computing device 2402 is described in detail as follows.

Computing device 2402 can be any of a variety of types of computing devices. Examples of computing device 2402 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 2402 is a stationary computing device such as a desktop computer, a personal computer (PC), a stationary server device, a minicomputer, a mainframe, a supercomputer, etc.

As shown in FIG. 24, computing device 2402 includes a variety of hardware and software components, including a processor 2410, a storage 2420, a graphics processing unit (GPU) 2442, a neural processing unit (NPU) 2444, one or more input devices 2430, one or more output devices 2450, one or more wireless modems 2460, one or more wired interfaces 2480, a power supply 2482, a location information (LI) receiver 2484, and an accelerometer 2486. Storage 2420 includes memory 2456, which includes non-removable memory 2422 and removable memory 2424, and a storage device 2488. Storage 2420 also stores an operating system 2412, application programs 2414, and application data 2416. Wireless modem(s) 2460 include a Wi-Fi modem 2462, a Bluetooth modem 2464, and a cellular modem 2466. Output device(s) 2450 includes a speaker 2452 and a display 2454. Input device(s) 2430 includes a touch screen 2432, a microphone 2434, a camera 2436, a physical keyboard 2438, and a trackball 2440. Not all components of computing device 2402 shown in FIG. 24 are present in all embodiments, additional components not shown may be present, and in a particular embodiment any combination of the components are present. In examples, components of computing device 2402 are mounted to a circuit card (e.g., a motherboard) of computing device 2402, integrated in a housing of computing device 2402, or otherwise included in computing device 2402. The components of computing device 2402 are described as follows.

In embodiments, a single processor 2410 (e.g., central processing unit (CPU), microcontroller, a microprocessor, signal processor, ASIC (application specific integrated circuit), and/or other physical hardware processor circuit) or multiple processors 2410 are present in computing device 2402 for performing such tasks as program execution, signal coding, data processing, input/output processing, power control, and/or other functions. In examples, processor 2410 is a single-core or multi-core processor, and each processor core is single-threaded or multithreaded (to provide multiple threads of execution concurrently). Processor 2410 is configured to execute program code stored in a computer readable medium, such as program code of operating system 2412 and application programs 2414 stored in storage 2420. The program code is structured to cause processor 2410 to perform operations, including the processes/methods disclosed herein. Operating system 2412 controls the allocation and usage of the components of computing device 2402 and provides support for one or more application programs 2414 (also referred to as “applications” or “apps”). In examples, application programs 2414 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 2410 includes one or more general processors (e.g., CPUs) configured with or coupled to one or more hardware accelerators, such as one or more NPUs 2444 and/or one or more GPUs 2442.

Any component in computing device 2402 can communicate with any other component according to function, although not all connections are shown for case of illustration. For instance, as shown in FIG. 24, bus 2406 is a multiple signal line communication medium (e.g., conductive traces in silicon, metal traces along a motherboard, wires, etc.) present to communicatively couple processor 2410 to various other components of computing device 2402, although in other embodiments, an alternative bus, further buses, and/or one or more individual signal lines is/are present to communicatively couple components. Bus 2406 represents one or more of any of several types of bus structures, including a memory bus or memory controller, a peripheral bus, an accelerated graphics port, and a processor or local bus using any of a variety of bus architectures.

Storage 2420 is physical storage that includes one or both of memory 2456 and storage device 2488, which store operating system 2412, application programs 2414, and application data 2416 according to any distribution. Non-removable memory 2422 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 2422 includes main memory and is separate from or fabricated in a same integrated circuit as processor 2410. As shown in FIG. 24, non-removable memory 2422 stores firmware 2418 that is present to provide low-level control of hardware. Examples of firmware 2418 include BIOS (Basic Input/Output System, such as on personal computers) and boot firmware (e.g., on smart phones). In examples, removable memory 2424 is inserted into a receptacle of or is otherwise coupled to computing device 2402 and can be removed by a user from computing device 2402. Removable memory 2424 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 2488 are present that are internal and/or external to a housing of computing device 2402 and are or are not removable. Examples of storage device 2488 include a hard disk drive, a SSD, a thumb drive (e.g., a USB (Universal Serial Bus) flash drive), or other physical storage device.

One or more programs are stored in storage 2420. Such programs include operating system 2412, one or more application programs 2414, and other program modules and program data. Examples of such application programs include computer program logic (e.g., computer program code/instructions) for implementing virtual machine 118A, virtual machine 118N, crypto handler 120A, crypto handler 120N, key cache 122A, key cache 122N, crypto handler 124, key vault 126, OS 202, application 204, enclave 206, enclave 804, hypervisor 806, virtual machines 808A-808C, interfaces 812A-812C, virtual functions 814A-814C, partition manager 818, key generator 1106A, key generator 1106N, encrypter 1108, decrypter 1110, cache monitor 1304, encrypter 1306, decrypter 1308, mitigation service 1602, attestor 1616, tamper event detector 1618, signing service 2206, firmware signer 2208, firmware generator 2210, firmware assignor 2212, HSM firmware loader 2214, manifest verifier 2216, firmware verifier 2218, mitigator 2220, ledger 2230, firmware 2232, firmware signer 2256, and/or the components described therein, and/or the steps of flowcharts 300, 400, 500, 700, 900, 1000, 1200, 1400, 1500, 1700, 1800, 1900, 2000, 2100, and/or 2300.

Storage 2420 also stores data used and/or generated by operating system 2412 and application programs 2414 as application data 2416. Examples of application data 2416 include web pages, text, images, tables, sound files, video data, and other data. In examples, application data 2416 is sent to and/or received from one or more network servers or other devices via one or more wired or wireless networks. Storage 2420 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 2402 through one or more input devices 2430 and receives information from computing device 2402 through one or more output devices 2450. Input device(s) 2430 includes one or more of touch screen 2432, microphone 2434, camera 2436, physical keyboard 2438 and/or trackball 2440 and output device(s) 2450 includes one or more of speaker 2452 and display 2454. Each of input device(s) 2430 and output device(s) 2450 are integral to computing device 2402 (e.g., built into a housing of computing device 2402) or are external to computing device 2402 (e.g., communicatively coupled wired or wirelessly to computing device 2402 via wired interface(s) 2480 and/or wireless modem(s) 2460). Further input devices 2430 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 2454 displays information, as well as operating as touch screen 2432 by receiving user commands and/or other information (e.g., by touch, finger gestures, virtual keyboard, etc.) as a user interface. Any number of each type of input device(s) 2430 and output device(s) 2450 are present, including multiple microphones 2434, multiple cameras 2436, multiple speakers 2452, and/or multiple displays 2454.

In embodiments where GPU 2442 is present, GPU 2442 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 2442 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 2444 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 2428. In an example, NPU 2444 is configured for a data-driven parallel computing and is highly efficient at processing massive multimedia data such as videos and images and processing data for neural networks. NPU 2444 is configured for efficient handling of AI-related tasks, such as speech recognition, background blurring in video calls, photo or video editing processes like object detection, etc.

In embodiments disclosed herein that implement ML models, NPU 2444 can be utilized to execute such ML models, of which MLM 2428 is an example. For instance, where applicable, MLM 2428 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 2444 is used to train MLM 2428. To train MLM 2428, training data is that includes input features (attributes) and their corresponding output labels/target values (e.g., for supervised learning) is collected. A training algorithm is a computational procedure that is used so that MLM 2428 learns from the training data. Parameters/weights are internal settings of MLM 2428 that are adjusted during training by the training algorithm to reduce a difference between predictions by MLM 2428 and actual outcomes (e.g., output labels). In some examples, MLM 2428 is set with initial values for the parameters/weights. A loss function measures a dissimilarity between predictions by MLM 2428 and the target values, and the parameters/weights of MLM 2428 are adjusted to minimize the loss function. The parameters/weights are iteratively adjusted by an optimization technique, such as gradient descent. In this manner, MLM 2428 is generated through training by NPU 2444 to be used to generate inferences based on received input feature sets for particular applications. MLM 2428 is generated as a computer program or other type of algorithm configured to generate an output (e.g., a classification, a prediction/inference) based on received input features, and is stored in the form of a file or other data structure.

In examples, such training of MLM 2428 by NPU 2444 is supervised or unsupervised. According to supervised learning, input objects (e.g., a vector of predictor variables) and a desired output value (e.g., a human-labeled supervisory signal) train MLM 2428. The training data is processed, building a function that maps new data on expected output values. Example algorithms usable by NPU 2444 to perform supervised training of MLM 2428 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 2428 is an LLM, MLM 2428 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 2428 is trained to learn patterns from unlabeled data. For instance, in embodiments where MLM 2428 implements unsupervised learning techniques, MLM 2428 identifies one or more classifications or clusters to which an input belongs. During a training phase of MLM 2428 according to unsupervised learning, MLM 2428 tries to mimic the provided training data and uses the error in its mimicked output to correct itself (i.e., correct weights and biases). In further examples, NPU 2444 perform unsupervised training of MLM 2428 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 2444 need not necessarily be present in all ML model embodiments. In embodiments where ML models are present, any one or more of processor 2410, GPU 2442, and/or NPU 2444 can be present to train and/or execute MLM 2428.

One or more wireless modems 2460 can be coupled to antenna(s) (not shown) of computing device 2402 and can support two-way communications between processor 2410 and devices external to computing device 2402 through network 2404, as would be understood to persons skilled in the relevant art(s). Wireless modem 2460 is shown generically and can include a cellular modem 2466 for communicating with one or more cellular networks, such as a GSM network for data and voice communications within a single cellular network, between cellular networks, or between the mobile device and a public switched telephone network (PSTN). In examples, wireless modem 2460 also or alternatively includes other radio-based modem types, such as a Bluetooth modem 2464 (also referred to as a “Bluetooth device”) and/or Wi-Fi modem 2462 (also referred to as an “wireless adaptor”). Wi-Fi modem 2462 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 2464 is configured to communicate with another Bluetooth-capable device according to the Bluetooth short-range wireless technology standard(s) such as IEEE 802.15.1 and/or managed by the Bluetooth Special Interest Group (SIG).

Computing device 2402 can further include power supply 2482, LI receiver 2484, accelerometer 2486, and/or one or more wired interfaces 2480. Example wired interfaces 2480 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 2480 of computing device 2402 provide for wired connections between computing device 2402 and network 2404, or between computing device 2402 and one or more devices/peripherals when such devices/peripherals are external to computing device 2402 (e.g., a pointing device, display 2454, speaker 2452, camera 2436, physical keyboard 2438, etc.). Power supply 2482 is configured to supply power to each of the components of computing device 2402 and receives power from a battery internal to computing device 2402, and/or from a power cord plugged into a power port of computing device 2402 (e.g., a USB port, an A/C power port). LI receiver 2484 is useable for location determination of computing device 2402 and in examples includes a satellite navigation receiver such as a Global Positioning System (GPS) receiver and/or includes other type of location determiner configured to determine location of computing device 2402 based on received information (e.g., using cell tower triangulation, etc.). Accelerometer 2486, when present, is configured to determine an orientation of computing device 2402.

Note that the illustrated components of computing device 2402 are not required or all-inclusive, and fewer or greater numbers of components can be present as would be recognized by one skilled in the art. In examples, computing device 2402 includes one or more of a gyroscope, barometer, proximity sensor, ambient light sensor, digital compass, etc. In an example, processor 2410 and memory 2456 are co-located in a same semiconductor device package, such as being included together in an integrated circuit chip, FPGA, or system-on-chip (SOC), optionally along with further components of computing device 2402.

In embodiments, computing device 2402 is configured to implement any of the above-described features of flowcharts herein. Computer program logic for performing any of the operations, steps, and/or functions described herein is stored in storage 2420 and executed by processor 2410.

In some embodiments, server infrastructure 2470 is present in computing environment 2400 and is communicatively coupled with computing device 2402 via network 2404. Server infrastructure 2470, when present, is a network-accessible server set (e.g., a cloud-based environment or platform). As shown in FIG. 24, server infrastructure 2470 includes clusters 2472. Each of clusters 2472 comprises a group of one or more compute nodes and/or a group of one or more storage nodes. For example, as shown in FIG. 24, cluster 2472 includes nodes 2474. Each of nodes 2474 are accessible via network 2404 (e.g., in a “cloud-based” embodiment) to build, deploy, and manage applications and services. In examples, any of nodes 2474 is a storage node that comprises a plurality of physical storage disks, SSDs, and/or other physical storage devices that are accessible via network 2404 and are configured to store data associated with the applications and services managed by nodes 2474.

Each of nodes 2474, as a compute node, comprises one or more server computers, server systems, and/or computing devices. For instance, a node 2474 in accordance with an embodiment includes one or more of the components of computing device 2402 disclosed herein. Each of nodes 2474 is configured to execute one or more software applications (or “applications”) and/or services and/or manage hardware resources (e.g., processors, memory, etc.), which are utilized by users (e.g., customers) of the network-accessible server set. In examples, as shown in FIG. 24, nodes 2474 includes a node 2446 that includes storage 2448 and/or one or more of a processor 2458 (e.g., similar to processor 2410, GPU 2442, and/or NPU 2444 of computing device 2402). Storage 2448 stores application programs 2476 and application data 2478. Processor(s) 2458 operate application programs 2476 which access and/or generate related application data 2478. In an implementation, nodes such as node 2446 of nodes 2474 operate or comprise one or more virtual machines, with each virtual machine emulating a system architecture (e.g., an operating system), in an isolated manner, upon which applications such as application programs 2476 are executed.

In embodiments, one or more of clusters 2472 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 2472 are included in a datacenter in a distributed collection of datacenters. In embodiments, exemplary computing environment 2400 comprises part of a cloud-based platform.

In an embodiment, computing device 2402 accesses application programs 2476 for execution in any manner, such as by a client application and/or a browser at computing device 2402.

In an example, for purposes of network (e.g., cloud) backup and data security, computing device 2402 additionally and/or alternatively synchronizes copies of application programs 2414 and/or application data 2416 to be stored at network-based server infrastructure 2470 as application programs 2476 and/or application data 2478. In examples, operating system 2412 and/or application programs 2414 include a file hosting service client configured to synchronize applications and/or data stored in storage 2420 at network-based server infrastructure 2470.

In some embodiments, on-premises servers 2492 are present in computing environment 2400 and are communicatively coupled with computing device 2402 via network 2404. On-premises servers 2492, when present, are hosted within an organization's infrastructure and, in many cases, physically onsite of a facility of that organization. On-premises servers 2492 are controlled, administered, and maintained by IT (Information Technology) personnel of the organization or an IT partner to the organization. Application data 2498 can be shared by on-premises servers 2492 between computing devices of the organization, including computing device 2402 (when part of an organization) through a local network of the organization, and/or through further networks accessible to the organization (including the Internet). Furthermore, in examples, on-premises servers 2492 serve applications such as application programs 2496 to the computing devices of the organization, including computing device 2402. Accordingly, in examples, on-premises servers 2492 include storage 2494 (which includes one or more physical storage devices such as storage disks and/or SSDs) for storage of application programs 2496 and application data 2498 and include a processor 2490 (e.g., similar to processor 2410, GPU 2442, and/or NPU 2444 of computing device 2402) for execution of application programs 2496. In some embodiments, multiple processors 2490 are present for execution of application programs 2496 and/or for other purposes. In further examples, computing device 2402 is configured to synchronize copies of application programs 2414 and/or application data 2416 for backup storage at on-premises servers 2492 as application programs 2496 and/or application data 2498.

Embodiments described herein may be implemented in one or more of computing device 2402, network-based server infrastructure 2470, and on-premises servers 2492. For example, in some embodiments, computing device 2402 is used to implement systems, clients, or devices, or components/subcomponents thereof, disclosed elsewhere herein. In other embodiments, a combination of computing device 2402, network-based server infrastructure 2470, and/or on-premises servers 2492 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 2420. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 2414) are stored in storage 2420. Such computer programs can also be received via wired interface(s) 2460 and/or wireless modem(s) 2460 over network 2404. Such computer programs, when executed or loaded by an application, enable computing device 2402 to implement features of embodiments discussed herein. Accordingly, such computer programs represent controllers of the computing device 2402.

Embodiments are also directed to computer program products comprising computer code or instructions stored on any computer-readable medium or computer-readable storage medium. Such computer program products include the physical storage of storage 2420 as well as further physical storage types.

### X. Additional Example Embodiments

A hardware security module is described herein. The hardware security module physically separate from and communicatively coupled to a host processor of a computing device. The hardware security module comprising a security coprocessor and a memory. The memory comprising programming instructions structured to cause the security coprocessor to: receive, over a network and from a central security module, a first cryptographic key, store the first cryptographic key in a secure data store, receive, from the host processor, a request to perform a cryptographic operation, utilize the first cryptographic key to perform the cryptographic operation, resulting in a cryptographic result.

In a further example of the foregoing hardware security module, the programming instructions are further structured to cause the security coprocessor to provide the cryptographic result to the host processor.

In a further example of the foregoing hardware security module, the programming instructions are further structured to cause the security coprocessor to provide, to the host processor, an indication that the cryptographic operation is completed.

In a further example of the foregoing hardware security module, the programming instructions are further structured to cause the security coprocessor to write the cryptographic result to host memory of the computing device, the host memory physically separate from the hardware security module.

In a further example of the foregoing hardware security module, to receive the first cryptographic key, the programming instructions are further structured to cause the security coprocessor to: establish a secure communication link with the central security module; and receive the first cryptographic key over the secure communication link.

In a further example of the foregoing hardware security module, to receive the first cryptographic key, the programming instructions are further structured to cause the security coprocessor to: receive an encrypted version of the first cryptographic key from the host processor, the encrypted version of the first cryptographic key encrypted with a public key preventing the host processor from accessing an unencrypted version of the first cryptographic key; and utilize a private key corresponding to the public key to decrypt the encrypted version of the first cryptographic key.

In a further example of the foregoing hardware security module, wherein the programming instructions are further structured to cause the security coprocessor to: generate a certificate comprising the public key, the certificate endorsing the host processor; cause the host processor to provide the certificate to the central security module, causing the central security module to utilize the public key to encrypt the first cryptographic key, resulting in an encrypted version of the first cryptographic key.

In a further example of the foregoing hardware security module, wherein to receive the request to perform a cryptographic operation, the programming instructions are further structured to cause the security coprocessor to: receive the request, the request comprising a pointer to a submission in queue; and access the submission based on the pointer, the submission indicating: a type of the cryptographic operation, a location of data to be manipulated by the cryptographic operation, a location to store the cryptographic result, an identifier of the host processor, an identifier of the virtual machine the request is on behalf of, or a type of encryption to utilize.

In a further example of the foregoing hardware security module, the request to perform the cryptographic operation is on behalf of a first virtual machine executed by the host processor. The hardware security module further comprises a first partition comprising a first interface and a second partition comprising a second interface. The programming instructions are further structured to cause the security coprocessor to bind the first virtual machine to the first partition. The binding configuring the first interface to receive the request to perform the cryptographic operation and preventing the first virtual machine from sending the request to the second interface.

In a further example of the foregoing hardware security module, the programming instructions are further structured to cause the security coprocessor to: receive, over the network and from the central security module, a second cryptographic key; bind a second virtual machine executed by the host processor to the second partition; utilize the first partition to perform cryptographic operations using the first cryptographic key on behalf of the first virtual machine; and utilize the second partition to perform cryptographic operations using the second cryptographic key on behalf of the second virtual machine.

In a further example of the foregoing hardware security module, the programming instructions are further structured to cause the security coprocessor to: receive an attribute from the host processor; generate a migration key based on the attribute; encrypt the first cryptographic key with the migration key, resulting in a wrapped key; and provide the wrapped key to the host processor.

In a further example of the foregoing hardware security module, the migration key is a symmetric key.

In a further example of the foregoing hardware security module, the migration key comprises a public migration key and a private migration key. The public migration key is configured to encrypt data or other information. The private migration key is configured for decrypting data or other information encrypted with the public migration key.

In a further example of the foregoing hardware security module, the hardware security module is located on a server device comprising the host processor, and the programming instructions are further structured to cause the security coprocessor to: monitor operation of hardware and firmware of the server device; and responsive to detecting a tamper event based on a result of said monitoring, perform a mitigation action based on the detected tamper event.

In a further example of the foregoing hardware security module, the programming instructions are further structured to cause the security coprocessor to, responsive to detecting the tamper event, transmit an indication of the tamper event to a mitigation service; and responsive to receiving a tamper risk signal from the mitigation service, perform the mitigation action.

In a further example of the foregoing hardware security module, wherein the mitigation action comprises: encrypting the first cryptographic key with a migration key, resulting in a wrapped key; and causing the wrapped key to be transmitted to another hardware security module.

In a further example of the foregoing hardware security module, the hardware security module detects the tamper event prior to the host processor booting an operating system.

In an alternative or additional example of the foregoing hardware security module, the programming instructions are configured to cause the security coprocessor to: receive key material over a network and from a central security module; generate a cryptographic key from the key material; receive, from the host processor, a request to perform a cryptographic operation; utilize the cryptographic key to perform the cryptographic operation; resulting in a cryptographic result; and provide, to the host processor, an indication that the cryptographic operation is completed.

In a further example of the foregoing hardware security module, the memory comprises a wrapping key. The programming instructions are further structured to cause the security coprocessor to: determine a storage criterion of the hardware security module is satisfied; utilize the wrapping key to encrypt the first cryptographic key, resulting in a wrapped key; and cause the host processor to store the wrapped key in a host memory.

In a further example of the foregoing hardware security module, the wrapping key is a wrapping key pair comprises a public wrapping key and a private wrapping key.

In a further example of the foregoing hardware security module, the programming instructions are further structured to cause the security coprocessor to: allotting the first partition a first number of credits and the second partition a second number of credits, wherein a credit is consumed responsive to the corresponding partition transferring data.

In a further example of the foregoing hardware security module, the programming instructions are further structured to cause the security coprocessor to: generate a migration key based on an attribute of the host processor; encrypt the first cryptographic key with the migration key, resulting in a wrapped key; and transmit the wrapped key to the second hardware security module, the transmission causing the second hardware security module to generate the migration key and utilize the migration key to unwrap the wrapped key.

In a further example of the foregoing hardware security module, the programming instructions are further structured to cause the security coprocessor to: receive an attribute from the first host processor, generate a migration key based on the attribute, encrypt the first cryptographic key with the migration key, resulting in a wrapped key, and cause a second hardware security module to receive the wrapped key, generate the migration key, and utilize the migration key to unwrap the wrapped key.

In a further example of the foregoing hardware security module, to cause the second hardware security module to generate the migration key, the programming instructions are further structured to cause the security coprocessor to: transmit the wrapped key to the first host processor; cause the first host processor to transmit the wrapped key to a second host processor communicatively coupled to the second hardware security module; and cause the second host processor to provide the attribute to the second hardware security module.

A system is described herein. The system comprises the foregoing hardware security module.

In a further example of the foregoing system, the system further comprises the foregoing host processor.

In a further example of the foregoing system, the foregoing hardware security module and foregoing host processor are incorporated in a first server device.

In a further example of the foregoing system, the system comprises a second server device. The second server device comprises a second hardware security module and a second host processor.

In a further example of the foregoing system, the system comprises the central security module.

In a further example of the foregoing system, the system comprises the host memory.

A method performed by a hardware security module is described herein. The hardware security module physically separate from and communicatively coupled to a host processor of a computing device. The method comprising: receiving, over a network and from a central security module, a first cryptographic key; storing the first cryptographic key in a secure data store; receiving, from the host processor, a request to perform a cryptographic operation; utilizing the first cryptographic key to perform the cryptographic operation, resulting in a cryptographic result.

In a further example of the foregoing method, the method further comprises providing the cryptographic result to the host processor.

In a further example of the foregoing method, further comprising providing, to the host processor, an indication that the cryptographic operation is completed.

In a further example of the foregoing method, the method further comprises writing the cryptographic result to host memory of the computing device, the host memory physically separate from the hardware security module.

In a further example of the foregoing method, said receiving the first cryptographic key comprises: establishing a secure communication link with the central security module; and receiving the first cryptographic key over the secure communication link.

In a further example of the foregoing method, said receiving the first cryptographic key comprises: receiving an encrypted version of the first cryptographic key from the host processor, the encrypted version of the first cryptographic key encrypted with a public key preventing the host processor from accessing an unencrypted version of the first cryptographic key; and utilizing a private key corresponding to the public key to decrypt the encrypted version of the first cryptographic key.

In a further example of the foregoing method, the method further comprises: generating a certificate comprising the public key, the certificate endorsing the host processor; causing the host processor to provide the certificate to the central security module, causing the central security module to utilize the public key to encrypt the first cryptographic key, resulting in an encrypted version of the first cryptographic key.

In a further example of the foregoing method, said receiving the request to perform a cryptographic operation comprises: receiving the request, the request comprising a pointer to a submission in queue; and accessing the submission based on the pointer. The submission indicates one or more of: a type of the cryptographic operation, a location of data to be manipulated by the cryptographic operation, a location to store the cryptographic result, an identifier of the host processor, an identifier of the virtual machine the request is on behalf of, or a type of encryption to utilize.

In a further example of the foregoing method, the request to perform the cryptographic operation is on behalf of a first virtual machine executed by the host processor. The hardware security module further comprises a first partition comprising a first interface and a second partition comprising a second interface. The method further comprises: binding the first virtual machine to the first partition. The binding configuring the first interface to receive the request to perform the cryptographic operation and preventing the first virtual machine from sending the request to the second interface.

In a further example of the foregoing method, the method further comprises: receiving, over the network and from the central security module, a second cryptographic key; binding a second virtual machine executed by the host processor to the second partition; utilizing the first partition to perform cryptographic operations using the first cryptographic key on behalf of the first virtual machine; and utilizing the second partition to perform cryptographic operations using the second cryptographic key on behalf of the second virtual machine.

In a further example of the foregoing method, the method further comprises: receiving an attribute from the host processor; generating a migration key based on the attribute; encrypting the first cryptographic key with the migration key, resulting in a wrapped key; and providing the wrapped key to the host processor.

In a further example of the foregoing method, the migration key is a symmetric key.

In a further example of the foregoing method, the migration key comprises a public migration key and a private migration key. The public migration key is configured for encrypting data or other information. The private key is configured for decrypting data or other information encrypted with the public migration key.

In a further example of the foregoing method, the hardware security module is located on a server device comprising the host processor, and the method further comprises: monitoring operation of hardware and firmware of the server device; and responsive to detecting a tamper event based on a result of said monitoring, performing a mitigation action based on the detected tamper event.

In a further example of the foregoing method, the method further comprises: responsive to detecting the tamper event, transmitting an indication of the tamper event to a mitigation service; and responsive to receiving a tamper risk signal from the mitigation service, performing the mitigation action.

In a further example of the foregoing method, wherein the mitigation action comprises: encrypting the first cryptographic key with a migration key, resulting in a wrapped key; and causing the wrapped key to be transmitted to another hardware security module.

In a further example of the foregoing method, the hardware security module detects the tamper event prior to the host processor booting an operating system.

In an alternative or additional example of the foregoing method, the method comprises: receiving key material over a network and from a central security module; generating a cryptographic key from the key material; receiving, from the host processor, a request to perform a cryptographic operation; utilizing the cryptographic key to perform the cryptographic operation; resulting in a cryptographic result; and providing, to the host processor, an indication that the cryptographic operation is completed.

In a further example of the foregoing method, hardware security module memory comprises a wrapping key. The method further comprises: determining a storage criterion of the hardware security module is satisfied; utilizing the wrapping key to encrypt the first cryptographic key, resulting in a wrapped key; and causing the host processor to store the wrapped key in a host memory.

In a further example of the foregoing method, the wrapping key comprises a wrapping key pair comprising a public wrapping key and a private wrapping key.

In a further example of the foregoing method, the method comprises: allotting the first partition a first number of credits and the second partition a second number of credits, wherein a credit is consumed responsive to the corresponding partition transferring data.

In a further example of the foregoing method, the method further comprises: generating a migration key based on an attribute of the host processor; encrypting the first cryptographic key with the migration key, resulting in a wrapped key; and transmitting the wrapped key to the second hardware security module, the transmission causing the second hardware security module to generate the migration key and utilize the migration key to unwrap the wrapped key.

In a further example of the foregoing method, the method further comprises: receiving an attribute from the host processor; generating a migration key based on the attribute; encrypting the cryptographic key with the migration key, resulting in a wrapped key; and causing a second hardware security module of a second computing device to receive the wrapped key, generate the migration key, and utilize the migration key to unwrap the wrapped.

In a further example of the foregoing method, said causing the second hardware security module to receive the wrapped key comprises: transmitting the wrapped key to the host processor, wherein said transmitting the wrapped key to the host processor causes the host processor to transmit the wrapped key to the second computing device, causing the second hardware security module to receive the wrapped key.

In a further example of the foregoing method, the attribute is an attribute of a virtual machine executed by the host processor, and wherein the method further comprises: causing the second computing device to execute a new instance of the virtual machine and provide the attribute to the second hardware security module, causing the second hardware security module to generate the migration key based on the attribute and utilize the migration key to unwrap the wrapped key.

A computer readable storage medium is described herein. The computer readable storage medium comprising programming instructions encoded thereon. The programming instructions structured to cause a security coprocessor to perform any of the foregoing methods.

### XI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, applications, computing devices, servers, central HSMs, distributed HSMs, host processors, security coprocessors, crypto handlers, virtual machines, enclaves, virtual functions, partition managers, HSM fabric controllers, initialization services, cache monitors, tamper event detectors, attestors, mitigating services, signing services, firmware assignors, firmware signers, ledgers, firmware generators, manifest verifiers, firmware verifiers, mitigators, firmware loaders, and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a first hardware security module communicatively coupled to and physically separate from a first host processor, the first hardware security module comprising:
a security coprocessor; and
a memory comprising programming instructions structured to cause the security coprocessor to:
receive, over a network and from a central security module, a first cryptographic key,
store the first cryptographic key in a secure data store,
receive an attribute from the first host processor,
generate a migration key based on the attribute,
encrypt the first cryptographic key with the migration key,
resulting in a wrapped key, and
cause a second hardware security module to receive the wrapped key, generate the migration key, and utilize the migration key to unwrap the wrapped key.

2. The system of claim 1, wherein to cause the second hardware security module to generate the migration key, the programming instructions are further structured to cause the security coprocessor to:
transmit the wrapped key to the first host processor;
cause the first host processor to transmit the wrapped key to a second host processor communicatively coupled to the second hardware security module; and
cause the second host processor to provide the attribute to the second hardware security module.

3. The system of claim 1, wherein to receive the first cryptographic key, the programming instructions are further structured to cause the security coprocessor to:
establish a secure communication link with the central security module; and
receive the first cryptographic key over the secure communication link.

4. The system of claim 1, wherein to receive the first cryptographic key, the programming instructions are further structured to cause the security coprocessor to:
receive an encrypted version of the first cryptographic key from the host processor, the encrypted version of the first cryptographic key encrypted with a public key preventing the host processor from accessing an unencrypted version of the first cryptographic key; and
utilize a private key corresponding to the public key to decrypt the encrypted version of the first cryptographic key.

5. The system of claim 4, wherein the programming instructions are further structured to cause the security coprocessor to:
generate a certificate comprising the public key, the certificate endorsing the host processor;
cause the host processor to provide the certificate to the central security module, causing the central security module to utilize the public key to encrypt the first cryptographic key, resulting in the encrypted version of the first cryptographic key.

6. The system of claim 1, wherein the request to perform the cryptographic operation is on behalf of a first virtual machine executed by the host processor, and wherein the hardware security module further comprises:
a first partition comprising a first interface;
a second partition comprising a second interface; and
wherein the programming instructions are further structured to cause the security coprocessor to:
bind the first virtual machine to the first partition, the binding configuring the first interface to receive the request to perform the cryptographic operation and preventing the first virtual machine from sending the request to the second interface.

7. The system of claim 6, wherein the programming instructions are further structured to cause the security coprocessor to:
receive, over the network and from the central security module, a second cryptographic key;
bind a second virtual machine executed by the host processor to the second partition;
utilize the first partition to perform cryptographic operations using the first cryptographic key on behalf of the first virtual machine; and
utilize the second partition to perform cryptographic operations using the second cryptographic key on behalf of the second virtual machine.

8. The system of claim 1, further comprising:
a first server device comprising the first hardware security module and the first host processor, wherein the programming instructions are further structured to cause the security coprocessor to:
monitor operation of hardware and firmware of the first server device; and
responsive to detecting a tamper event based on a result of said monitoring, cause the first host processor to transmit the migration key to a second server device comprising the second hardware security module.

9. The system of claim 1, wherein the programming instructions are further structured to cause the security coprocessor to:
determine a storage criterion of the first hardware security module is satisfied;
encrypt the first cryptographic key, resulting in an encrypted version of the first cryptographic key; and
cause the first host processor to store the encrypted version in a host memory.

10. A method performed by a first hardware security module physically separate from and communicatively coupled to a host processor of a first computing device, the method comprising:
receiving key material over a network and from a central security module;
generating a cryptographic key from the key material;
receiving an attribute from the host processor;
generating a migration key based on the attribute;
encrypting the cryptographic key with the migration key, resulting in a wrapped key; and
causing a second hardware security module of a second computing device to receive the wrapped key, generate the migration key, and utilize the migration key to unwrap the wrapped key.

11. The method of claim 10, wherein said causing the second hardware security module to receive the wrapped key comprises:
transmitting the wrapped key to the host processor,
wherein said transmitting the wrapped key to the host processor causes the host processor to transmit the wrapped key to the second computing device, causing the second hardware security module to receive the wrapped key.

12. The method of claim 10, wherein the attribute is an attribute of a virtual machine executed by the host processor, and wherein the method further comprises:
causing the second computing device to execute a new instance of the virtual machine and provide the attribute to the second hardware security module, causing the second hardware security module to generate the migration key based on the attribute and utilize the migration key to unwrap the wrapped key.

13. The method of claim 10, further comprising:
binding a virtual machine to a first partition of the hardware security module;
causing the first partition to perform the cryptographic operation on behalf of the virtual machine;
preventing the virtual machine from sending the request to a second partition that is separate from the first partition.

14. The method of claim 13, further comprising allotting the first partition a first number of credits and the second partition a second number of credits, wherein a credit is consumed responsive to the corresponding partition transferring data.

15. A first hardware security module physically separate from and communicatively coupled to a host processor of a first computing device, comprising:
a security coprocessor; and
a memory comprising programming instructions structured to cause the security coprocessor to:
store a first cryptographic key in a secure data store,
receive an attribute from the host processor,
generate a migration key based on the attribute,
encrypt the first cryptographic key with the migration key, resulting in a wrapped key, and
cause a second computing device to receive the wrapped key, generate the migration key, and utilize the migration key to unwrap the wrapped key.

16. The first hardware security module of claim 15, wherein to cause the second computing device to receive the wrapped key, the programming instructions are further structured to cause the security coprocessor to:
transmit the wrapped key to the host processor, wherein said transmission to the host processor causes the host processor to transmit the wrapped key to the second computing device.

17. The first hardware security module of claim 16, wherein the attribute is an attribute of a virtual machine executed by the host processor, and wherein the programming instructions are further structured to cause the security processor to:
cause the second computing device to execute a new instance of the virtual machine and provide the attribute to a second hardware security module of the second computing device, causing the second hardware security module to generate the migration key based on the attribute and utilize the migration key to unwrap the wrapped key.

18. The first hardware security module of claim 15, wherein the programming instructions are further structured to cause the security coprocessor to:
generate a certificate comprising the public key, the certificate endorsing the host processor;
cause the host processor to provide the certificate to the central security module, causing the central security module to utilize the public key to encrypt the first cryptographic key, resulting in an encrypted version of the first cryptographic key, the host processor unable to access an unencrypted version of the first cryptographic key;
receive the encrypted version of the first cryptographic key from the host processor; and
utilize a private key corresponding to the public key to decrypt the encrypted version of the first cryptographic key.

19. The first hardware security module of claim 15, wherein the request to perform the cryptographic operation is on behalf of a first virtual machine executed by the host processor, and wherein the hardware security module further comprises:
a first partition comprising a first interface;
a second partition comprising a second interface; and
wherein the programming instructions are further structured to cause the security coprocessor to:
bind the first virtual machine to the first partition, the binding configuring the first interface to receive the request to perform the cryptographic operation and preventing the first virtual machine from sending the request to the second interface.

20. The first hardware security module of claim 17, wherein the programming instructions are further structured to cause the security coprocessor to:
receive, over the network and from the central security module, a second cryptographic key;
bind a second virtual machine executed by the host processor to the second partition;
utilize the first partition to perform cryptographic operations using the first cryptographic key on behalf of the first virtual machine; and
utilize the second partition to perform cryptographic operations using the second cryptographic key on behalf of the second virtual machine.
